(19) United States
(12) Patent Application Publication
(10) Pub. No.: US 2015/0379198 A1
(43) Pub. Date: Dec. 31, 2015

(54) ELECTRONIC MANAGEMENT OF PATIENT HEALTH CARE DATA

(71) Applicant: Access My Records, Inc., Boca Raton, FL (US)

(72) Inventor: Leonard J. TAMBASCO, JR., Boca Raton, FL (US)

(21) Appl. No.: 14/314,099

(22) Filed: Jun. 25, 2014

(51) Int. Cl. G06F 19/00

(52) U.S. Cl. CPC G06F 19/322

(57) ABSTRACT

Various embodiments manage access to patient health-related information in a health care patient portal. In one embodiment, a determination is made that a user has accessed the health care patient portal. A set of electronic health-related records associated with the user is identified. A source identifier associated with each record is also identified. The source identifier is associated with an entity that provided the electronic health-related record to the health care patient portal. A sharing status associated with each record is determined. The sharing status indicates that the associated electronic health-related record is one of sharable and non-sharable with an entity other than the user. The records are presented to the user in the health care patient portal. A least one record is presented with the source identifier and the sharing status associated with the record.

### BACKGROUND

The present disclosure generally relates to the electronic management of patient health-medical data, and more particularly relates to managing and presenting patient health-medical data from different types of sources in a patient health care portal.

Health care providers have traditionally maintained all of their patients' information in paper filing systems. However, this practice is very inefficient and lends itself to poor management practices of the patient's data. Accordingly, Electronic Health Management Systems (EHMS) have been developed to provide many of the functionalities and features of paper filing systems in an electronic paperless format. These systems streamline workflow processes and clinical, financial, and administrative information. Electronic Health Management Systems also improve coding and billing accuracy. However, patients generally do not have access to EHMSs to manage and provide their health-related data.

### BRIEF SUMMARY

In one embodiment, a method for managing access to patient health-related information in a health care patient portal is disclosed. The method comprises determining, by an information processing system comprising a health care patient portal, that a user has accessed the health care patient portal. A set of electronic health-related records associated with the user is identified. A source identifier associated with each of the set of electronic health-related records is also identified. The source identifier is associated with an entity that provided the electronic health-related record to the health care patient portal. A sharing status associated with each of the set of electronic health-related records is determined. The sharing status indicates that the associated electronic health-related record is one of sharable and non-sharable with an entity other than the user. The set of electronic health-related records is presented to the user in the health care patient portal. The at least one of the set of electronic health-related records is presented with the source identifier and the sharing status associated with the at least one of the set of electronic health-related records.

In another embodiment, an information processing system for managing access to patient health-related information in a health care patient portal is disclosed. The information processing system comprises memory and a processor communicatively coupled to the memory. The information processing system also comprises a health care patient portal and a portal manager. The portal manager is configured to perform a method. The method comprises receiving, from a at least one source, a set of electronic health-related records associated with at least one user. A source identifier is assigned to each of the set of electronic health-related records identifying the source as one of the user based on receiving the set of electronic health-related records an entity integrated with the health care patient portal, and an entity that fails to be integrated with the health care patient portal. A determination is made that the user has accessed the health care patient portal. The set of electronic health-related records associated with the user is retrieved. The source identifier associated with each of the set of health-related records is identified. A sharing status associated with each of the set of health-related records is determined. The sharing status indicates that the associated electronic health-related record is one of sharable and non-sharable with an entity other than the user. The set of electronic health-related records is presented to the user in one or more user-customizable widgets within the health care patient portal. At least one of the set of electronic health-related records is presented with the source identifier and the sharing status associated with the at least one of the set of electronic health-related records.

In yet another embodiment, a computer program storage product managing access to patient health-related information in a health care patient portal is disclosed. The computer program storage product comprising instructions configured to perform a method. The method comprises determining, by an information processing system comprising a health care patient portal, that a user has accessed the health care patient portal. A set of electronic health-related records associated with the user is identified. A source identifier associated with each of the set of electronic health-related records is also identified. The source identifier is associated with an entity that provided the electronic health-related record to the health care patient portal. A sharing status associated with each of the set of electronic health-related records is determined. The sharing status indicates that the associated electronic health-related record is one of sharable and non-sharable with an entity other than the user. The set of electronic health-related records is presented to the user in the health care patient portal. The at least one of the set of electronic health-related records is presented with the source identifier and the sharing status associated with the at least one of the set of electronic health-related records.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 is a block diagram illustrating a detailed view of a patient portal manager according to one embodiment of the present disclosure;

FIG. 3 shows one example of an electronic record according to one embodiment of the present disclosure;

FIG. 4 shows one example of a facility profile for a patient portal according to one embodiment of the present disclosure;

FIG. 5 shows one example of a subscriber profile for a patient portal according to one embodiment of the present disclosure;

FIG. 6 shows one example of a user profile for a patient portal according to one embodiment of the present disclosure;

FIG. 7 shows one example of a patient portal displaying a home section to a user according to one embodiment of the present disclosure;

FIG. 8 shows one example of a patient portal displaying a clinical summary section to a user according to one embodiment of the present disclosure;

FIG. 9 shows one example of a patient portal displaying a messaging section to a user according to one embodiment of the present disclosure;

FIG. 10 shows one example of a patient portal displaying an appointment section to a user according to one embodiment of the present disclosure;

FIG. 11 shows one example of a patient portal displaying a medication section to a user according to one embodiment of the present disclosure;

FIG. 12 shows one example of a patient portal displaying a doctor management section to a user according to one embodiment of the present disclosure;

FIG. 13 shows one example of a patient portal displaying an emergency contact section to a user according to one embodiment of the present disclosure;

FIG. 14 shows one example of a patient portal displaying a records sharing section to a user according to one embodiment of the present disclosure;

FIG. 15 shows one example of a patient portal displaying authentication credentials for a health care provider to access the patient portal to view a patient's health-related data according to one embodiment of the present disclosure;

FIG. 16 shows one example of a patient portal displaying an emergency medical records section to a user according to one embodiment of the present disclosure;

FIG. 17 shows one example of a patient portal displaying a medical portfolio section to a user according to one embodiment of the present disclosure;

FIG. 18 shows one example of a patient portal displaying a document section to a user according to one embodiment of the present disclosure;

FIG. 19 shows one example of a patient portal displaying a record view, download, and transmit section to a user according to one embodiment of the present disclosure;

FIG. 20 is an operational flow diagram illustrating one example of an overall process for managing access to patient health-related information in a health care patient portal according to one embodiment of the present disclosure;

FIG. 21 is an operational flow diagram illustrating another example of an overall process for managing access to patient health-related information in a health care patient portal according to one embodiment of the present disclosure;

FIG. 22 is a block diagram illustrating one example of an information processing system according to one embodiment of the present disclosure; and

FIG. 23 shows one example of the structure and format of a continuity of care document (CCD).

### DETAILED DESCRIPTION

Operating Environment

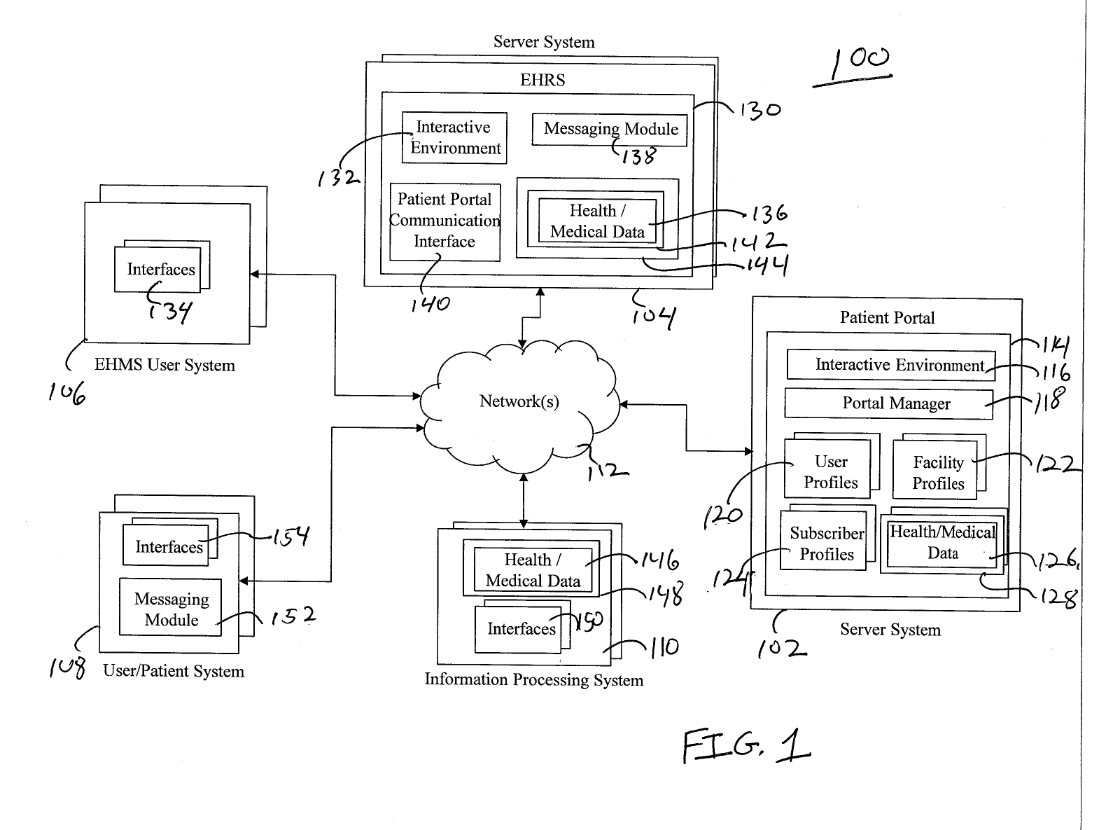

FIG. 1 illustrates one example of an operating environment 100 according to one embodiment of the present disclosure. The operating environment 100, in this embodiment, comprises a plurality of information processing systems 102, 104, 106, 108, 110 communicatively coupled to one or more networks 112. The information processing systems 102, 104, 106, 108, 110 comprise server systems, user systems, and/or the like. Examples of user systems include (but are not limited to) desktop computers; servers; portable computing devices such as laptop computers mobile/smart phones, tablets, wearable computing devices (e.g., smart watches), personal digital assistants, etc.; and the like. In one embodiment, one or more of the information processing systems 102, 104, 106, 108, 110 are part of a cloud-computing environment or a non-cloud computing environment.

The network(s) 112 comprises a local area network (LAN), a general wide area network (WAN), and/or a public network (e.g., the Internet). The network(s) 112, in one embodiment, also comprises a wireless communication network that supports any wireless communication standard such as, but not limited to, a Wireless Fidelity (WiFi) network, Global System for Mobile Communications (GSM), Code Division Multiple Access (CDMA), Time Division Multiple Access (TDMA), General Packet Radio Service (GPRS), Frequency Division Multiple Access (FDMA), Orthogonal Frequency Division Multiplexing (OFDM), or the like. The wireless communication network includes one or more networks based on such standards. For example, in one embodiment, the wireless communication network comprises one or more of a Long Term Evolution (LTE) network, LTE Advanced (LTE-A) network, an Evolution Data Only (EV-DO) network, a GPRS network, a Universal Mobile Telecommunications System (UMTS) network, and the like.

At least one system 102 comprises a patient portal 114. The patient portal 114 is a health care-related website and/online application (e.g., a cloud-based application) or service (e.g., a cloud-based service) that allows patients (also referred to herein as “patients”) to securely manage and view their health information created by one or more health care providers (e.g., physicians and hospitals) and/or provided by the patient. It should be noted that throughout this disclosure health-related information comprises medical-related information and vice versa, unless otherwise noted.

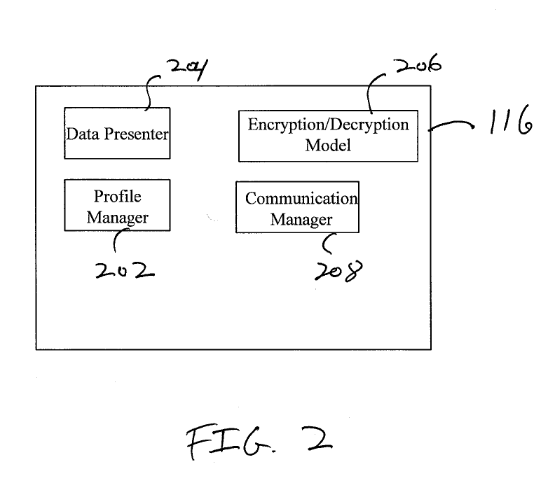

The patient portal 114 also allows a registered patient to securely interact and communicate with their health care providers. In one embodiment, the patient portal 114 comprises an interactive environment 116 and a patient portal manager 118. The patient portal manager 118 comprises a profile manager 202 (FIG. 2), a data presenter 204, a data encryption/decryption module 206, and a communication manager 208. The patient portal 114 further comprises user profiles 120, facility profiles 122, subscriber profiles 124, and user health-medical data 126 stored within one more electronic records 128. Each of these components is discussed in greater detail below.

In one embodiment, at least a second of the system 104 comprises an electronic record management system such as an Electronic Health Management System (EHMS) 130. It should be noted that an EHMS 130 can also reside on a user system 106 and/or within a local network comprising a user system 106. An EHMS 130 comprises and/or is based on, for example Electronic Medical Record (EMR) Systems, Electronic Health Record (EHR) Systems, Personal Health Record (PHR) Systems, Practice Management Software Systems, Health Information Exchanges (HIEs), and device and software vendors systems in the patient health care continuum.

The EHMS 130 comprises an interactive environment 132 that allows health care professionals to interact with the EHMS 130 via one or more interfaces 134 (e.g., applications, user interfaces, web browsers, and/or the like) residing on their user system 106. In one embodiment, the EHMS user system 106 and its users are associated with a facility such as a physician's office, a hospital, an imaging center, a laboratory, and/or the like. A single EHMS 130 can be associated with a single facility or multiple facilities. The EHMS 130 further comprises, among other things, patient health-medical data 136, a messaging module 138 (e.g., an email application, a Short Message Service (SMS) messaging application, a Multimedia Messaging Service (MMS) messaging application, a network adapter, and/or the like) and a patient portal communication interface 140, which implements an application programming interface (API) for the patient portal 114.

The communication interface 140 can be part of the messaging module 138 or separate from the messaging module 138. In another embodiment, the messaging module 138 is not required and the communication interface 140 performs the same functions as the messaging module 138. The patient portal communication interface 140 enables the EHMS 130 to securely communicate with the patient portal 114. The patient health/medial data 136, in one embodiment, is stored within one or more electronic records 142, which are maintained within one or more databases 144. The database(s) 144 can be part of the EHMS 130, separate from the EHMS 130, reside on the system 104, and/or reside on or across one or more remote information processing systems.

The EHMS 130 allows a user such as a health care provider to create and manage electronic records 142 for his/her patients. Examples of electronic records 142 include EMRs, EHMS, PHRs, records generated by Practice Management Software Systems, records generated by HIEs, and/or any other types of electronic records generated within the patient health care continuum. It should be noted that the terms “Electronic Health Records” and “Electronic Medical Records” can be used interchangeably. EHMS and EMRs are systematic collections of electronic health information associated with a specific individual (patient) or population. An EHR comprises various types of information such as patient medical history, immunization status/history, lab results, medication and allergy information, radiology images, vital signs, personal statistics (e.g., age, weight, and height), demographics, billing information, and/or the like.

An EHR/EMR can be a patient created in hospitals and ambulatory environments using an Electronic Health Management System (EHMS) 130 either on the network residing locally at the hospital or ambulatory environment who created the record. An EHR/EMR is generally an internal record generated and maintained within an institution to give patients, physicians and other health care providers, employers, and payers or insurers access to a patient's medical records across facilities. An EHR/EMR software vendor produces software to manage Electronic Health Records for the health care providers use. A PHR is an online accessible health record that is maintained by the patient and comprises health data and information related to the care of the patient. The patient generally provides the information to be maintained by a PHR.

In one embodiment, an EHMS 130 comprising a patient portal communication interface 140 is referred to as an “integrated partner”, an “integrated subscriber”, and/or as being “integrated” with the patient portal 114. Also, a facility and/or provider that utilizes an EHMS 130 that is registered/integrated with the patient portal 114 is also referred to as an “integrated partner”, an “integrated subscriber”, and/or as being “integrated” with the patient portal 114. However, embodiments of the present disclosure are not limited to integrated EHMSs, facilities, and providers. The patient portal 114 is also able to communicate with non-integrated EHMSs, facilities, providers. For example, FIG. 1 shows one or more information processing systems 110, which can comprise an EHMS and/or be an EHMS user system. These systems 110 comprise patient-related health-medical data 146 stored within one or more records 148, images, and/or the like. These systems 110 also comprise one or more interfaces 150 (e.g., applications, user interfaces, web browsers, and/or the like). A patient portal communication interface 140 does not reside on these systems and, therefore, these systems are considered to be not integrated with the patient portal 114. However, these systems 110 are able to utilize one or more of their interfaces 150 to transmit and receive unstructured, semi-structured, and/or structured data to/from the patient portal 114, as will be discussed in greater detail below.

As discussed above, one or more health care professionals interact with the EHMS 130 via one or more interfaces 134 on an EHMS user system 106. In particular, health care professionals interact with the interactive environment 132 of the EHMS 130 to enter, store, and manage various medical and health related data/information associated with a given patient. For example, the health care professional can enter administrative and billing data, patient demographics, progress notes, vital signs, medical histories, diagnoses, medications, immunization dates, allergies, radiology images, lab and test results, and/or the like into the EHMS 130. The EHMS 130 generates and maintains at least one electronic record 142 for the identified patient/user based on the data entered.

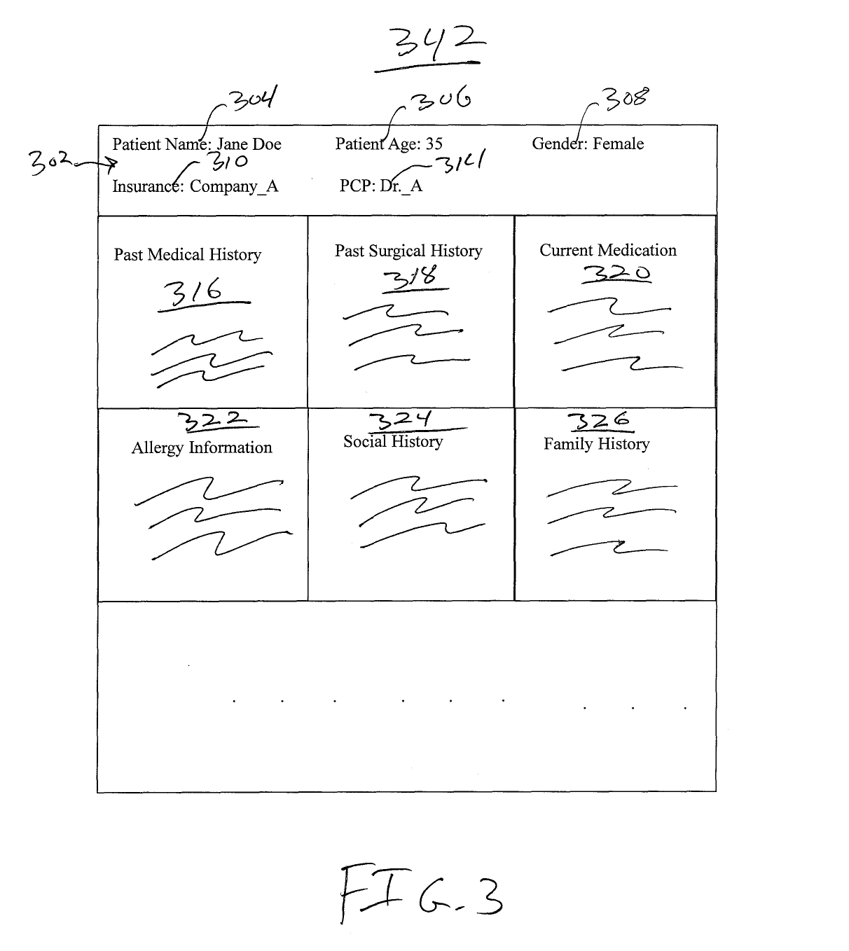

FIG. 3 shows one example of an electronic record(s) 342 generated by the EHMS 130 and displayed to a health care professionals interacting with the interactive environment 132. In this example, the electronic record(s) 342 is an EHR. However, the EHMS 130 is not limited to only generating EHMS and can generate any type of electronic record associated with a patient. FIG. 3 shows the interactive environment 132 being displayed to the health care professional via the interface 134 on his/her system 106. Within the interactive environment 132, an EHR 342 is displayed to the health care professional. The EHR 342 comprises a first portion 302 displaying general patient data such as patient name 304, patient age 306, patient gender 308, patient insurance 310, patient primary care physician 312, and various other types of data. At least a second portion 314 of the EHR 342 displays either all of the health-medical related information associated with the patient or displays a portion of this information as selected by the health care professional. In the example shown in FIG. 3, the EHR 342 displays a patient summary comprising various types of medical/health related information such as past medical history 316, past surgical history 318, current medication 320, allergy information 322 social history 324, family history 326, and/or the like.

Communicating with the Patient Portal

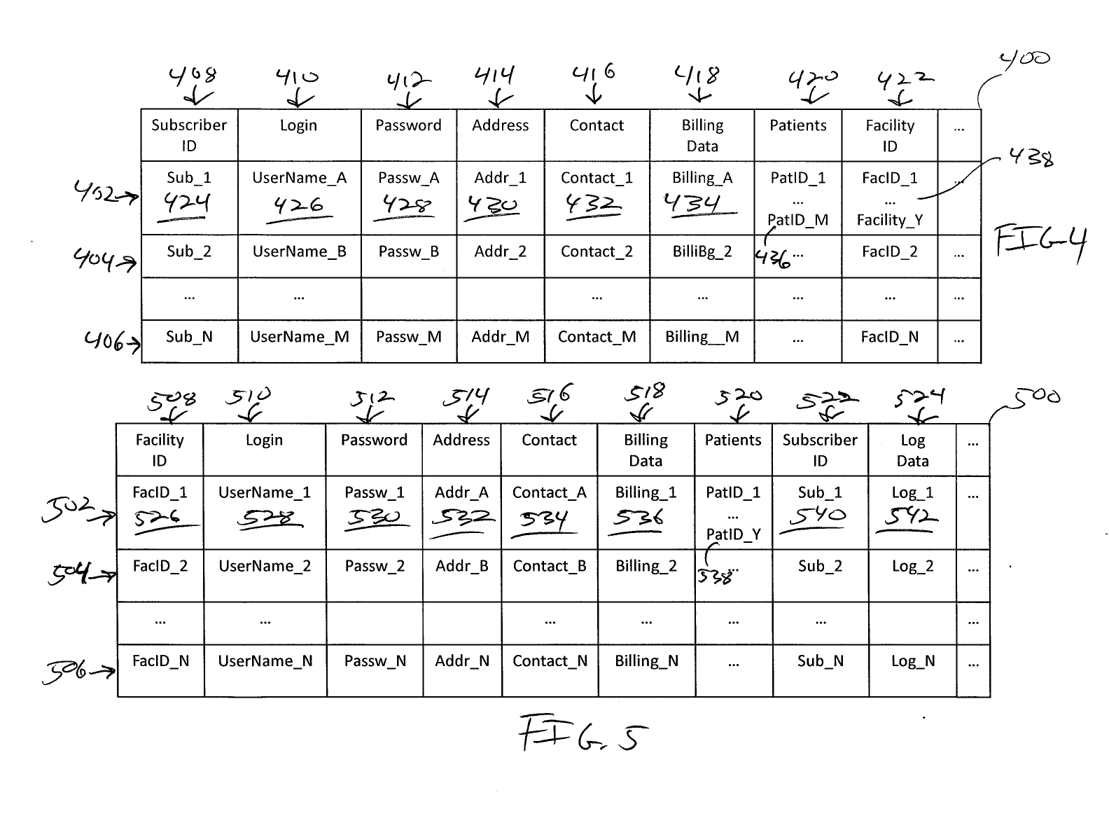

In one embodiment, the EHMS 130 is communicatively coupled to the patient portal 114 such that the EHMS 130 is able to send and receive messages to/from the patient portal 114, transmit electronic records 142 and other data to the portal 114, and/or the like. In one embodiment, the EHMS 130 has been previously been registered with the patient portal 114 and is associated with a subscriber profile 124 for the portal 114. FIG. 4 shows various examples of subscriber profiles 124. In the example shown in FIG. 4, each row 402, 404, 406 in the table 400 corresponds to a subscriber profile. It should be noted that in other embodiments, each subscriber profile 402, 404, 406 is stored separate from one another. The table 400 comprises a plurality of columns, each storing a different set of information. In this example, the table 400 comprises a first column 408 entitled “Subscriber ID”; a second column 410 entitled “Login”; a third column 412 entitled “Password”, a fourth column 414 entitled “Address”; a fifth column 416 entitled “Contact”; a sixth column 418 entitled “Billing Data”; a seventh column 420 entitled “Patients”; and an eighth column 422 entitled “Facility ID”.

The “Subscriber ID” column 408 comprises entries 424 uniquely identifying the EHMS associated with the subscriber profile. The “Login” column 410 comprises entries 426 with the unique login or user name assigned to the EHMS for interacting with the patient portal. The “Password” column 412 comprises entries 428 with the unique password assigned to the EHMS for interacting with the patient portal 114. The “Address” column 414 comprises entries 430 with the address of the EHMS. The “Contact” column 416 comprises entries 432 that identify the contact person at the EHMS who manages the EHMS's account with the patient portal 114. The “Billing Data” column 418 comprises entries 434 with various types of billing data associated with the EHMS (if applicable). Examples of billing data include subscription plan type, payment information, payment histories, and/or the like. The “Patients” column 420 comprises entries 436 with the patient ID (or a pointer to the user profile 120) of each patient associated with the EHMS. The “Facility ID” column 422 comprises entries 438 with the subscriber ID of the facilities associated with the EHMS 130. It should be noted that one or more of the columns and entries shown in FIG. 4 are optional, and additional information can be included within a subscriber profile 124 as well.

In one embodiment, when the EHMS 130 wants to communicate with the patient portal 114 the communication interface 140 establishes a secured/authenticated link with the patient portal 114. In one example, the communication interface 140 provides authentication information via the communication interface 140 to the portal 114 to obtain a security token for that session period. For example, the communication interface 140 of the EHMS 130 sends the following message to the patient portal 114:

```
<?xml version=″1.0″ encoding=″utf-8″?>
<soap12:Envelope xmlns:xsi=″http://www.w3.org/2001/XMLSchema-instance″
xmlns:xsd=″http://www.w3.org/2001/XMLSchema″
xmlns:soap12=″http://www.w3.org/2003/05/soap-envelope″>
  <soap12:Body>
    <AuthenticateInterface xmlns=″http://tempuri.org/″>
      <FacilityId>long</FacilityId>
      <UserLogin>string</ UserLogin>
      <Password>string</Password>
    </AuthenticateInterface>
  </soap12:Body>
</soap12:Envelope>
```

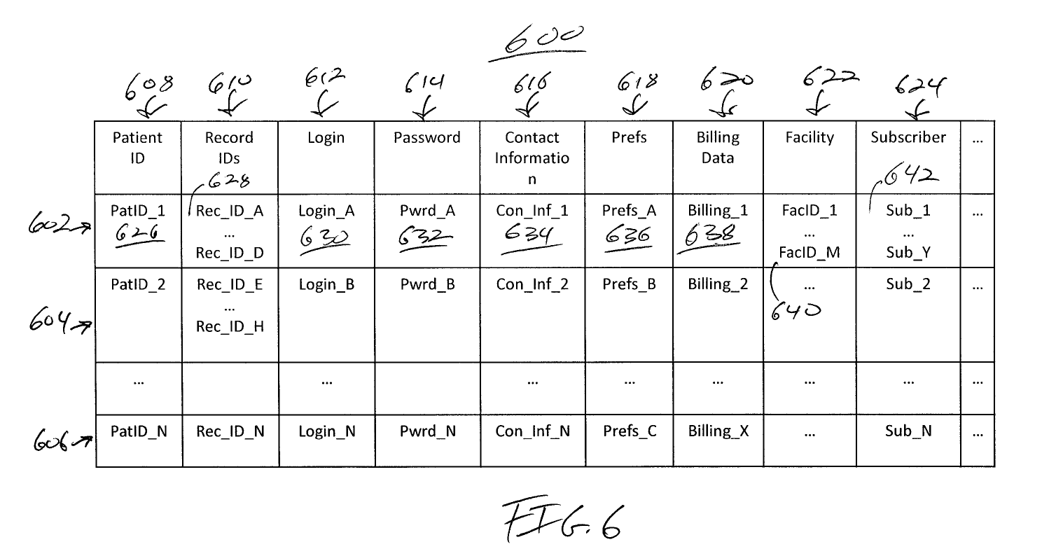

This message/request includes the identifier of the facility (e.g., health care provider) associated with the transmission, the login associated with the facility for the patient portal 114, and the password associated with the facility for the patient portal 114. It should be noted that authentication request/message received from the EHMS 130 can include any type of information that allows the patient portal to identify the facility and/or EHMS 130 associated with the request. The patient portal 114 receives this message and the communication manager 208 analyzes a set of facility profiles 122 to determine if the requesting facility has been previously registered. FIG. 5 shows various examples of facility profiles 122. In the example shown in FIG. 5, each row 502, 504, 506 in the table 500 corresponds to a facility profile. It should be noted that in other embodiments, each facility profile 502, 504, 506 is stored separate from one another. The table 500 comprises a plurality of columns, each storing a different set of information. In this example, the table 500 comprises a first column 508 entitled “Facility ID”; a second column 510 entitled “Login”; a third column 512 entitled “Password”, a fourth column 514 entitled “Address”; a fifth column 516 entitled “Contact”; a sixth column 518 entitled “Billing Data”; a seventh column 520 entitled “Patients”; an eighth column 522 entitled “Subscriber ID”; and a ninth column 524 entitled “Log Data”.

The “Facility ID” column 508 comprises entries 526 uniquely identifying the facility (e.g., physician's office, hospital, etc.) associated with the facility profile. The “Login” column 510 comprises entries 528 with the unique login or user name assigned to the facility for interacting with the patient portal. The “Password” column 512 comprises entries 530 with the unique password assigned to the facility for interacting with the patient portal 114. The “Address” column 514 comprises entries 532 with the address of the facility. The “Contact” column 515 comprises entries 534 that identify the contact person at the facility who manages the facility's account with the patient portal. The “Billing Data” column 518 comprises entries 535 with various types of billing data associated with the facility (if applicable). Examples of billing data include subscription plan type, payment information, payment histories, and/or the like. The “Patients” column 520 comprises entries 538 with the patient ID (or a pointer to the user profile 120) of each patient associated with the facility. The “Subscriber ID” column 522 comprises entries 540 with the subscriber ID of the EHMS 130 associated with the facility. The “Log Data” column 524 comprises entries 542 with various types of log data such as a record of patient logins for the facilities, the time and date of a patient login, and/or the like. It should be noted that one or more of the columns and entries shown in FIG. 5 are optional, and additional information can be included within a facility profile 122 as well.

In another embodiment, the authentication request/message received from the EHMS 130 includes information associated with the EHMS 130 in addition to or in place of the facility information. For example, the authentication request/message comprises an identifier of the EHMS 130 associated with the transmission, the login associated with the EHMS 130 for the patient portal, and/or the password associated with the EHMS 130 for the patient portal. The patient portal 114 receives this message and the communication manager 208 analyzes a set of subscriber profiles 124 to determine if the requesting facility has been previously registered.

The communication manager 208 analyzes the facility profiles 122 (and/or subscriber profiles 124) to determine if any of the profiles comprises a facility ID (and/or EHMS ID) matching the facility ID (and/or EHMS ID) within the authentication request message. If a match exists, the communication manager 208 further analyzes the profiles 120/124 to determine if the user name or login information transmitted within the authentication request message matches the information within the identified facility profile 122 (and/or subscriber profile 124). Based on this analysis, the communication manager 208 transmits a response message back to the EHMS 130 via the communication interface 140 either granting the authentication request or denying it. For example, the communication manager 208 sends the following message to the EHMS 130:

```
<?xml version=″1.0″ encoding=″utf-8″?>
<soap12:Envelope xmlns:xsi=″http://www.w3.org/2001/XMLSchema-instance″
xmlns:xsd=″http://www.w3.org/2001/XMLSchema″
xmlns:soap12=″http://www.w3.org/2003/05/soap-envelope″>
  <soap12:Body>
  <AuthenticateInterfaceResponse xmlns=″http://tempuri.org/″>
    <AuthenticateInterfaceResult>
      <Valid>boolean</Valid>
      <Token>string<Token>
      <ErrorMessage>string</ErrorMessage>
    </AuthenticateInterfaceResult>
  </AuthenticateInterfaceResponse>
  </soap12:Body>
</soap12:Envelope>
```

The above message comprises a “Valid” value if the request from the EHMS 130 was successfully processed; otherwise a “False” value is returned. If the request could not be successfully processed, the message also comprises an error message indicating the reason why the request was denied. If the request was successfully processed the communication manager 208 also sends a security token for the transmission to the EHMS 130. It should be noted that the process above can be similarly performed for authentication of an EHMS 130 as well. Also, the above messages are only one example of an authentication request and response that can be sent by the EHMS 130 and portal 114. Various other messages with different formats and content are applicable as well.

Once the EHMS 130 has obtained a security token, it can securely send and receive data to/from the patient portal 114. For example, the EHMS 130 is able to send a communication to the patient portal 114 for creating an account for a patient within the portal 114 and to map this account to the patient's account in the EHMS 130. In this example, the communication interface 140 generates a request/message with the portal-based patient ID if this ID has been provided by the patient. The following is one example of a request generated by the communication interface 140 for creating/linking a patient account in the portal:

```
<?xml version=″1.0″ encoding=″utf-8″?>
<soap12:Envelope xmlns:xsi=http://www.w3.org/2001/XMLSchema-instance
xmlns:xsd=″http://www.w3.org/2001/XMLSchema″
xmlns:soap12=″http://www.w3.org/2003/05/soap-envelope″>
  <soap12:Body>
    <CreateAMRPatient xmlns=″http://tempuri.org/″>
      <FacilityId>long</FacilityId>
      <UserId>long</UserId>
      <Token>string</Token>
      <PatientData>
        <AMRPatientId>long</AMRPatientId>
        <Salutation>string</Salutation>
        <FirstName>string</FirstName>
        <MiddleName>string</MiddleName>
        <LastName>string</LastName>
        <Address1>string</Address1>
        <Address2>string</Address2>
        <Address3>string</Address3>
        <City>string</City>
        <State>string</State>
        <Postal>string</Postal>
        <CountryCode>string</CountryCode>
        <HomePhone>string</HomePhone>
        <MobilePhone>string</MobilePhone>
        <WorkPhone>string</WorkPhone>
        <Fax>string</Fax>
        <EMail>string</EMail>
        <DOB>dateTime</DOB>
        <SSN>string</SSN>
        <PreferredLanguageId>int</PreferredLanguageId>
        <GenderId>int</GenderId>
        <RaceId>int</RaceId>
        <EthnicityId>int</EthnicityId>
        <MaritalStatusId>int</MaritalStatusId>
        <SmokingStatusId>int</SmokingStatusId>
      </PatientData>
    </CreateAMRPatient>
  </soap12:Body>
</soap12:Envelope>
```

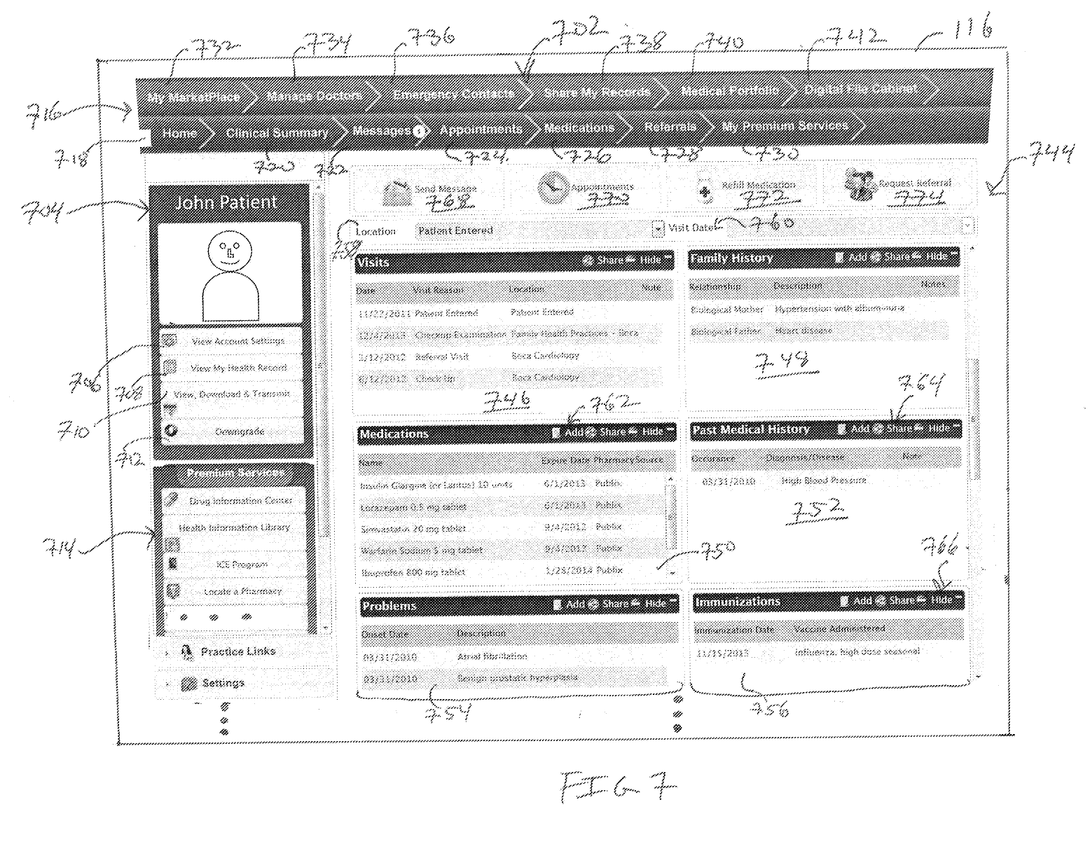

When the portal 114 receives this message, the profile manager 202 searches the user profiles 120 to identify a profile comprising the portal-based patient ID (e.g., “AMRPatientID”). FIG. 6 shows various examples of user profiles 120. In the example shown in FIG. 6, each row 602, 604, 606 in the table 600 corresponds to a user profile. It should be noted that in other embodiments, each patient profile 602, 604, 606 is stored separate from one another. The table 600 comprises a plurality of columns, each storing a different set of information. In this example, the table 600 comprises a first column 608 entitled “Patient ID”; a second column 610 entitled “Record IDs”; a third column 612 entitled “Login”; a fourth column 614 entitled “Password”, a fifth column 616 entitled “Contact Information”; a sixth column 618 entitled “Prefs”; a seventh column 620 entitled “Billing Data”; and eighth column 622 entitled “Facilities”, and a ninth column 624 entitled “Subscriber”.

The “Patient ID” column 608 comprises entries 626 uniquely identifying the patient associated with the user profile for the patient portal 114. The “Login” column 610 comprises entries 628 with the unique login or user name assigned to the patient for interacting with the patient portal 114. The “Record IDs” column 612 comprises entries 630 uniquely identifying health-medical data 126 and records 128 associated with the patient and maintained by the patient portal 114. These record IDs can also point to a location where the data 126 and/or records 128 are stored. In one embodiment, the records 128 are the records received from the EHMS 130 (or the patient) and/or are records created by the patient portal 114 using the health-medical data 136 within an electronic record 142 received from the EHMS 130 (or the patient). The patient portal 114 is able to receive electronic records in various different formats, parse and extract their information, and generate its own electronic records 128 based on the extracted information. In this embodiment, the record IDs are associated with and/or pointing to the patient portal generated records 128.

The “Password” column 614 comprises entries 632 with the unique password assigned to the patient for interacting with the patient portal. The “Contact Information” column 616 comprises entries 634 identifying the contact information of the patient such as email addresses, home address, phone numbers, and/or the like. The “Prefs” column 618 comprises entries 636 that identify the patient preferences with respect to the patient portal. For example, the patient can configure how the data presenter 204 presents information to the patient in the patient portal 114. In this example, the patient is able to select and configure the types of information that are displayed to the patient in the portal 114. Preferences can also include contact preferences and any other preferences that the patient is able to configure with respect to the patient portal 114. The “Billing Data” column 620 comprises entries 638 with various types of billing data associated with the patient (if applicable). Examples of billing data include subscription plan type, payment information, payment histories, and/or the like. The “Facility” column 622 comprises entries 640 with the facility ID (or a pointer to the facility profile 122) of each facility associated with the patient. The “Subscriber” column 624 comprises entries 642 with the subscriber ID (or a pointer to the subscriber profile 121) of each EHMS associated with the patient. It should be noted that one or more of the columns and entries shown in FIG. 6 are optional, and additional information can be included within a user profile 120 as well.

Once the profile manager 202 identifies the user profile 120 comprising a patient ID matching the ID sent in the request/message received from the EHMS 130, the manager 202 updates the profile 122 to link the user profile 122 to the EHMS 130 and/or facility. For example, the profile manager 202 updates the profile 122 to include the subscriber ID of the EHMS 130, the Facility ID of the facility, a pointer to the subscriber profile 124 of the EHMS 130, a pointer to the facility profile 122 of the facility, and/or the like.

In some embodiments, the EHMS 130 may not have been provided the portal-based identifier for the patient. In this embodiment, the profile manager 202 searches for a user profile 120 comprising data matching the patient identifying information and demographics provided in the communication received from the EHMS 130. If a matching profile 120 is identified, the portal 114 sends a communication to the EHMS 130 comprising the portal-based ID of the patient and the EHMS 130 updates its records accordingly. If a matching profile 120 cannot be identified, the portal manager 118 automatically registers the patient and generates a user profile 120 for the patient comprising the patient identifying information and demographics received from the EHMS 130. It should be noted that the portal 114 is not limited to automatically creating a presence for a patient based on an explicit request from the EHMS 130. For example, the portal 114 can also automatically create a presence for the patient, a facility, and/or an EHMS within the portal 114 based on receiving patient health-medical data from the EHMS 130 as discussed in the co-pending U.S. patent application Ser. No. ______, entitled “Automatic Generation Of Patient Presence For Patient Portals” filed on ______, which is hereby incorporated by reference in its entirety.

The portal 114 sends a communication to the EHMS 130 comprising the portal-based ID of the patient, and the EHMS 130 updates its records accordingly. The portal 114 can also send a welcome letter to the EHMS 130. The appropriate provider associated with the EHMS 130 then provides this welcome letter to the patient. In one embodiment, the welcome letter at least provides a portal login for the patient, a portal password for the patient, and/or a uniform resource locator (URL) for the patient portal 114. The following is one example of the response sent to the EHMS 130 from the portal 114 based on a request from the EHMS 130 for creating/linking a patient account in the portal:

```
<?xml version=″1.0″ encoding=″utf-8″?>
  <soap12:Envelope xmlns:xsi=″http//www.w3.org/2001/XMLSchema-instance″
  xmls:xsd=″http://www.w3.org/2001/XMLSchema″
  xmlns:soap12=″http://www.w3.org/2003/05/soap-envelope″>
    <soap12:Body>
      <CreateAMRPatientResponse xmlns=″http://tempuri.org/″>
        <CreateAMRPatientResult>
          <Valid>boolean</Valid>
          <ErrorMessage>string</ErrorMessage>
          <AMRPatientId>long</AMRPatientId>
          <WelcomeLetter>string</WelcomeLetter>
        </CreateAMRPatientResult>
      </CreateAMRPatientResponse>
    </soap12:Body>
  </soap12:Envelope>
```

The above message/response comprises a “Valid” value if the request from the EHMS 130 was successfully processed; otherwise a “False” value is returned. If the request could not be successfully processed, the message also comprises an error message indicating the reason why the request was denied. If the request was successfully processed the response comprises the portal-based patient ID and a welcome letter (if applicable). It should be noted that above messages are only one example of a patient account creation/linking request and response that can be sent by the EHMS 130 and portal 114. Various other messages with different formats and content are applicable as well.

In addition to creating/linking a patient account in the portal 114, the EHMS 130 can also request to create and/or link a provider account in the portal 114. Examples of providers includes (but are not limited to) doctors, nurse practitioners, physicians assistants, nurses, and/or the like. This communication is similar to the one shown above and comprises the identifier of the facility associated with the communication the userID (login) of the facility for the portal 114; the security token returned by the authentication process discussed above; and a data structure comprising provider data including the identifier of the provider in the EHMS system 130, the title of the provider, the first name of the provider, the middle name of the provider, the last name of the provider, the DEA number of the provider, the license number of the provider, the provider's home phone, the patient's email address, and/or the like. The portal 114 processes this communication and stores the provider data as health-medical data 126, which can be stored in one or more records 128. Also, the user profiles 120, facility profiles 122, and subscriber profiles 124 can be updated to include the received provider data or at least a pointer to the provider data (or record 128 comprising the data).

Another type of communication that is sent from the EHMS 130 to the portal 114 is a patient health-related record/data communication, which comprises patient health-related information. In one embodiment, the data 136 from an electronic record 142 is transmitted to the patient portal 114 according to one or more standards; however this is not required. In this embodiment, structured and/or unstructured data (including attachments in binary form) comprising patient identifying information, patient health-related information, patient medical-related information, and/or the like is sent to the patient portal 114. For example, an electronic record 142 can be transmitted from the EHMS 130 or the system 108 of an individual patient as structured and/or unstructured data, a Continuation of Care Record (CCR), a Continuity of Care Document (CCD) or one of its equivalents/permutations, an unstructured clinical document architecture (CDA) record, and/or the like. In one embodiment, an integrated facility/EHMS sends structured data while a non-integrated facility/EMRS sends unstructured (or semi-structured) data); however, this is not required and each can sent any type of data to the patient portal 114. It should be noted that embodiments of the present disclosure are not limited to such examples, and electronic records 142 or their data can be transmitted to the patient portal 114 in any format.

CCRs and CCDs are both data sets conforming to specific health record standard specifications. A CCR comprises a summary of a patient's health status including medications, allergies, problems, insurance information, care plans, and/or the like. There are six sections of a CCR that have mandated core elements. These sections include a header, patient identifying information, patient financial and insurance information, health status of the patient, care documentation, and care plan recommendation. A CCD document comprises a dataset that conforms to an XML-based markup standard that specifies the semantics, encoding, and structure of a patient summary clinical document. A CCD comprises information such as the “Common MU Data Set”, where “MU” stands for Meaningful Use, This data set comprises Patient name, sex, date of birth, race, ethnicity, preferred language, smoking status, problems, medications, medication allergies, laboratory tests, laboratory values/results, vital signs, care plan fields including goals and instructions, procedures and care team members. Other information such as referral reasons, discharge instructions, encounter diagnoses, and immunizations can also be included within a CCD.

A CCD document is a human and machine-readable document comprising structured and, optionally, unstructured content. A CCD is generated according to the Clinical Document Architecture (CDA), which is an HL7 authored health care documentation standard. The CDA is a base standard that provides common architecture, coding, semantic framework, and markup language for the creation of electronic clinical documents. FIG. 23 shows one example of the structure and format of a CCD 2302. In this example, the CCD comprises a header 2304, a body 2306, and one or more sections 2308. The one or more sections 2308 comprise a narrative block 2310, and one or more entries 2312.

The header 2304 sets the context for the CCD as a whole. The header 23023 allows management of the CCD and allows it to be exchanged across and within different institutions. The body 2306 comprises the clinical report and can comprise structured content that is organized into one or more sections 2308. The body 2306 can also comprise an unstructured set of data as well. Each section 2308 comprises a narrative block 2310 and, optionally, one or more coded entries such as medications, allergies, immunizations, vital signs, and problems. Narrative blocks 2310 provide human-readability of a CCD. The narrative block within a document section 2308 represents the content to be rendered for viewing. Entries 2312 provide machine-readability to the CCD. Entries 2312 within a document section 2308 represent structured content for further computer processing. The EHMS 130 is able to generate a CCD using one or more CDA-based templates. The EHMS 130 can select from one or more header templates, a body templates, and section templates, narrative block templates, and entry templates. Each of these templates is designed to satisfy a specific information exchange scenario and defines the CDA structures to be used to document the applicable clinical information.

In one embodiment, the EHMS 130 is configured to automatically transmit a patient's electronic records 142 once they are created or after one or more predefined conditions have occurred. For example, after a doctor has evaluated the patient and has reviewed the information entered into the patient's record 142 at the EHMS 132, the doctor selects an option to save the record 142. The EHMS 132 detects that the record has been saved and automatically sends the data 136 within the record 142 to the patient portal 114. It should be noted that other conditions are applicable as well such as the completion and signing of a clinical note, the signing of lab results, temporal conditions, and/or the like. Alternatively, a health care professional can manually instruct the EHMS 130 to transmit a patient's electronic data 136 and/or records 142 to the patient portal 114.

When the EHMS 130 detects that an automatic sending condition has occurred or receives an instruction from an EHMS user system 106, the EHMS 130 transmits one or more electronic records 142 to the patient portal 114. The record/data can be packaged as a CCR, CCD, unstructured CDA, and/or the like; however this is not required. The following is one example of a communication comprising patient clinical data that is sent from the EHMS 130 to the portal 114:

```
<?xml version=″1.0″ encoding=″utf-8″?>
  <soap12:Envelope xmlns:xsi=″http//www.w3.org/2001/XMLSchema-instance″
  xmls:xsd=″http://www.w3.org/2001/XMLSchema″
  xmlns:soap12=″http://www.w3.org/2003/05/soap-envelope″>
    <soap12:Body>
      <CCDPost xmlns=″http://tempuri.org/″>
        <FacilityId>long</FacilityId>
        <UserId>long</UserId>
        <Token>string<Token>
        <CCDData>
          <AMRPatientId>long</AMRPatientId>
          <Document>base64Binary</Document>
        </CCDData>
      </CCDPost>
    </soap12:Body>
  </soap12:Envelope>
```

In this example, the communication generated by the EHMS 130 comprises the ID of the facility associated with the communication; the userID (login) of the facility for the portal 114; the security token returned by the authentication process discussed above; and a data structure comprising the portal-based patient identifier of the patient associated with the communication, and a CCD document converted to a byte string. It should be noted that a similar communication can also be sent by the EHMS 130 comprising patient visit-based data such as the visit identifier; the provider identifier; visit reason; insurance information; a problem list comprising a SNOMED Codes, Code Types for the SNOMED Codes, condition information, the data the condition was identified, condition status, notes on the condition; medication information; allergy information; vital signs; family history information; social history information; medical history information; surgical history information; medical procedure information; immunization information; plan of care information; and/or the like.

Lab result data can also be included within a communication similar to the one shown above. This communication comprises, for example, the userID (login) of the facility for the portal 114; the security token returned by the authentication process discussed above; and a data structure comprising an identifier of the lab visit, the portal-based patient identifier of the patient associated with the communication, the identifier of the provider who ordered the lab, the name of the lab, the date/time the lab was ordered, the date/time the sample was collected, the requisition number, the specimen code, the source of the specimen, the date/time the report was ordered, the date/time the report was reviewed, the name of the reviewed, the component tested, the result, the reference range, the measurement units, an indication of the results were normal/abnormal, results status, and/or the like.

In addition, the EHMS 130 is able to send documents such as clinical and medical notes to the EHMS 130 using a communication similar to the one shown above. In one embodiment, the document is sent as an image; however this is not required. In this embodiment, the communication comprises the ID of the facility associated with the communication; the userID (login) of the facility for the portal 114; the security token returned by the authentication process discussed above; and a data structure comprising data associated with the document such as an identifier associated with the visit, the portal-based patient identifier associated with the patient, an identifier or name of the document in the sending system, a description of the document (or document name), the date/time the document was created, the document image format (e.g., PDF, TIF, etc.), the document image, any notes on the document, and/or the like.

Once received by the portal 114, the communication manager 208 processes the communication from the EHMS 130 and stores the health-related data and/or record included within the communication. In one embodiment, the portal manager 118 generates one or more portal records 128 comprising the health-medical data 126 received in the communication. This allow the patient portal 114 to receive health-related records and data in any format and process the data independent of the EHMS 130 that sends the record/data. The profile manager 202 of the portal 114 updates the user profile 120 for the patient identified in the communication. For example, the profile manager 202 updates the user profile 120 to include a pointer to the data 126 and/or record 128 (or an identifier associated therewith). Once the portal 114 has processed the communication received from the EHMS 130, it sends a response back to the EHMS similar to the responses discussed above. It should be noted that above message is only one example of an health-related data communication and response that can be sent by the EHMS 130 and portal 114. Various other messages with different formats and content are applicable as well.

In addition to sending the patient portal 114 various types of health-related information, the EHMS 130 can also check for and respond to messages waiting to be processed at the patient portal 114. In one embodiment, the EHMS 130 checks for messages at the portal 114 at scheduled intervals; however, the portal 114 can also send a notification to the EHMS 130 indicating that a message is waiting to be processed. In this embodiment, the EHMS 130 sends a communication similar to those discussed above along with an indication that it is checking for messages. The portal 114 receives this communication and responds back with a response similar to those discussed above. In one example, the response sent by the portal 114 comprises an indication whether the request from the EHMS 130 was successfully processed; an error message if the request was not successfully processed; and a data structure comprising an identifier of each waiting message, the portal-based patient identifier of the patient associated with the message, the message type (e.g., appointment request, medication refill, billing message, general inquiry, referral message, and/or the like), an optional identification of the provider to which the message is addressed, text request from the patient, preferred time of day for an appointment (if applicable), preferred time for appointment (if applicable), preferred day(s) for appointment (if applicable), patient entered text as to why they need an appointment (if applicable), visit urgency (if applicable), name of medication (if applicable), name of pharmacy (if applicable), and/or the like. The EHMS 130 responds to this message by sending a message similar to those above along with message identifier, the identifier of the provider who is responding, the response to the request, responses to each of the request within the message, and any attachments (e.g., prescriptions).

In some embodiments, the communications sent between the EHMS 130 and the portal 114 are transmitted via one or more secured mechanisms; however this is not required. For example, the EHMS 130 and the patient portal 114 are each associated with a security key pair that is used to encrypt/decrypt information being transmitted there between. In one embodiment, the messaging module 138 and/or the communication interface 140 encrypts the communications sent from the EHMS 130 with the public key of the patient portal 114, and also signs the communication with the private key of the EHMS 130. The communication interface 140 then sends the encrypted communication to the patient portal 114 via the secure communication link. It should be noted that the message and/or their data are not required to be encrypted prior to being sent to the patient portal 114 since the secure communication link provides an encrypted pipe such that the messages are securely encapsulated when being transmitted to the patient portal 114.

In addition, the EHMS 130 and the patient portal 114 can utilize one or more information exchange technologies such as DIRECT messaging (DIRECTProject.org), which provide secure messaging between sender and recipient parties, to transmit information between each other. For example, DIRECT messaging can be utilized to send secure emails, secure point-to-point messages (utilizing, for example, the Cross Enterprise Reliable Interchange (XDR) interface), and/or the like between the EHMS 130 and patient portal 114. Secure email utilizes the S/MIME standard for exchanging encrypted emails. With DIRECT messaging, certificates of the sending/receiving parties can be automatically discovered and retrieved across various networks such as the Internet.

In an embodiment where DIRECT messaging is to be used, the EHMS 130 and the patient portal 114 are each associated with a security key pair that is used to encrypt information being transmitted there between. The EHMS 130 and patient portal can send secured messages directly to each other and/or through one or more third-party servers. In an embodiment, where third-party servers are utilized, the EHMS 130 and patient portal 114 are both part of the same or different secured/trust network such as those provided by Health care Information Service Providers (HISPs). In this embodiment, the EHMS 130 generates an electronic communication (e.g., email message) comprising an electronic record 142 or its data addressed to a DIRECT messaging address (e.g., DIRECT-messaging-based email address) of the patient portal 114. In one embodiment, the electronic record 142 or its data is packaged in a CCR, CCD or unstructured CDA form; however this is not required.

When utilizing DIRECT messaging, the messaging module 138 of EHMS 130 sends the electronic communication to the patient portal 114 through at least one source trust server. This trust server receives the electronic communication and identifies the destination address, which is the messaging address of the patient portal 114. The trust server identifies the security certificate of the patient portal 114, generates an S/MIME-based message, and signs the message with the private key of the EHMS 130. The trust server further encrypts the message with the certificate (public key) of the patient portal 114 and sends this encrypted message to the patient portal 114.

The patient portal 114 can then receive the electronic communication in its encrypted form and perform decrypting operations itself. Alternatively, a destination trust server can intercept this encrypted communication and perform, for example, an S/MIME decryption process using the private key of the patient portal. After the communication and its content are decrypted, this trust server verifies the communication using a certificate (public key) of the EHMS 130. Once verified, the destination trust server sends the decrypted communication with its content to the patient portal 114 using its DIRECT messaging address. The patient portal 114 receives the communication from the EHMS 130 along with its data (e.g., electronic records/data) in an unencrypted form.

In another embodiment, the third-party servers are not required. For example, the EHMS 130 and the patient portal can securely communication directly with each other. In this embodiment, the messaging module 138 of the EHMS 130 implements or is communicatively coupled to the patient portal communication interface 140. In one embodiment, the communication interface 140 utilizes standard web services protocols that transfer messages in a markup language format. These messages can be transmitted over HTTP or another protocol. The communication interface 140, in one embodiment, utilizes one or more security technologies such as SSL (Security Socket Layer) over HTTPS to securely communicate and encrypt the data exchange and communications between the EHMS 130 and the patient portal 114. The communication interface 140 utilizes one or more information exchange technologies such as DIRECT messaging to transmit information to the patient portal 114.

In another embodiment, a secure communication link is not established between the EHMS 130 and patient portal 114. In this embodiment, the messaging module 138 of the EHMS 130 securely encrypts the electronic records 142 prior to transmitting them to the patient portal 114. In this embodiment, the messaging module 138 generates a message/packet comprising the encrypted data and sends the message to a messaging address (e.g., email address) of the patient portal. In another embodiment, the EHMS 130 transmits data to the patient portal 114 in an unsecured form over an unsecured link. It should be noted that embodiments of the present disclosure are not limited to the above examples directed to securely transmitting electronic record data to the patient portal 114. Other mechanisms for securely transmitting electronic record data to the patient portal 114 are applicable as well.

It should also be noted that the above discussion is applicable to sending electronic records/data or images thereof from a user/patient system 108 via a messaging module 152 such as an application, plug-in, web browser, and/or the like residing on a user/patient system 108. The user/patient system 108 can also comprise one or more interfaces 154 such as the patient portal communication interface discussed above for communicating with the patient portal 114. In addition, a patient is able to utilize a device such as a wireless communication device, a portable electronic device, a desktop computer, and/or the like to capture an image of an object comprising his/her health related information. For example, the patient can have health or medical related data in paper form such as lab results, doctors' records, prescriptions, radiology images, radiology reports, physical therapy treatment plans, hand written health or medical related information, and/or the like.

The patient is able to utilize a camera, scanner, and/or the like to capture in an image of these items, and transmit the image to the patient portal 114 for processing. Alternatively, the patient's device 108 can also process the image and send health-related data items to the patient portal. The patient transmits his/her health or medical related information to the patient portal via one via one or more communication mechanisms such as via an email message, a SMS message, a MMS message, a DIRECT message, by uploading to the portal 114 through a web browser, transmission through a dedicate portal application 114 residing on the user's system 108, and/or the like. A more detailed discussion on one more examples of a patient transmitting health-related data to the patient portal 114 is given in the co-pending U.S. patent application Ser. No. ______, entitled “User-Based Remote Capturing Of Health And Medical Related Data” filed on ______, which is incorporated by reference in its entirety.

Also, embodiments of the present disclosure are not limited to a facility, EHMS, and/or a patient that has been previously registered with the patient portal 114. For example, an unregistered entity is able to utilize a browser to upload structured, semi-structured, and/or unstructured data (including attachments in binary form) to the patient portal. These unregistered entities are also able to send an email message, SMS message, MMS message, instant message, DIRECT message, and/or the like to a messaging address of the patient portal comprising health-related data within the subject and body sections of the message (and/or attached thereto). The patient portal 114 receives the communications from unregistered entities and processes them similar to that discussed above including creating (automatically or based on a request from the sending entity) a presence for the unregistered entities associated with the communication in the portal 114). Therefore, the patient portal 114 is able to receive communications comprising health-related data/requests from registered and unregistered EHMSs, facilities, and patients.

When the patient portal 114 receives a communication comprising health-related information, the communication manager 208 extracts the data/record(s) included within (or attached to) the communication. The data/record(s) is stored as health-medical data 126 and can be maintained in one or more records 128. The portal manager 118 can maintain the records/data in the form they were received and/or generate one or more portal-based records 128 comprising the information therein. It should be noted that if the received records/data comprises structured data, the portal manager 118 can maintain the structure and formatting properties of the data/records.

In one embodiment, the communication manager 208 identifies and records the source of the health-medical data 126 (and records 128 when the are the records received from a source and not generated by the portal manager 118). Stated differently, the communication manager 208 identifies and records whether the health-medical data 126 was received from an integrated partner, a non-integrated entity, or a patient. For example, if the health-medical data 126 was received from a patient, the communication manager 208 assigns a source type of “patient entered” to the health-medical data 126. If the health-medical data 126 was received from an integrated partner, the communication manager 208 assigns a source type of “integrated partner” to the health-medical data 126. The identifier and/or the name of the subscriber/facility that sent the health-medical data 126 can also be assigned to the record/data as the source type as well. If the health-medical data 126 was received from a non-integrated entity, the communication manager 208 assigns a source type of “non-integrated” to the health-medical data 126. The identifier and/or the name of the non-integrated subscriber/facility that sent the health-medical data 126 can also be assigned to the health-medical data 126 as the source type as well. The source type can be added as an annotation to the stored health-medical data 126, added as a field in the health-medical data 126, and/or the like. If the portal manager 118 generates a record 128 from the health-medical data 126 extracted from a communication, the assigned source type is included within this record 128.

It should be noted that instead of (or in addition to) a source type being assigned to received health-medical data 126, the communication manager 208 can store the health-medical data 126 (and records 128) in a section of memory/storage that is allocated for a given source type. For example, a first portion of storage can be allocated for health-medical data 126 received from integrated partners. A second portion of storage can be allocated for health-medical data 126 received from non-integrated partners. A third portion of storage can be allocated for health-medical data 126 received from patients. Therefore, the portal manager 118 is able to determine the source type of stored health-medical data 126 based on which portion of storage they are maintained in.

Patient Interaction with the Patient Portal

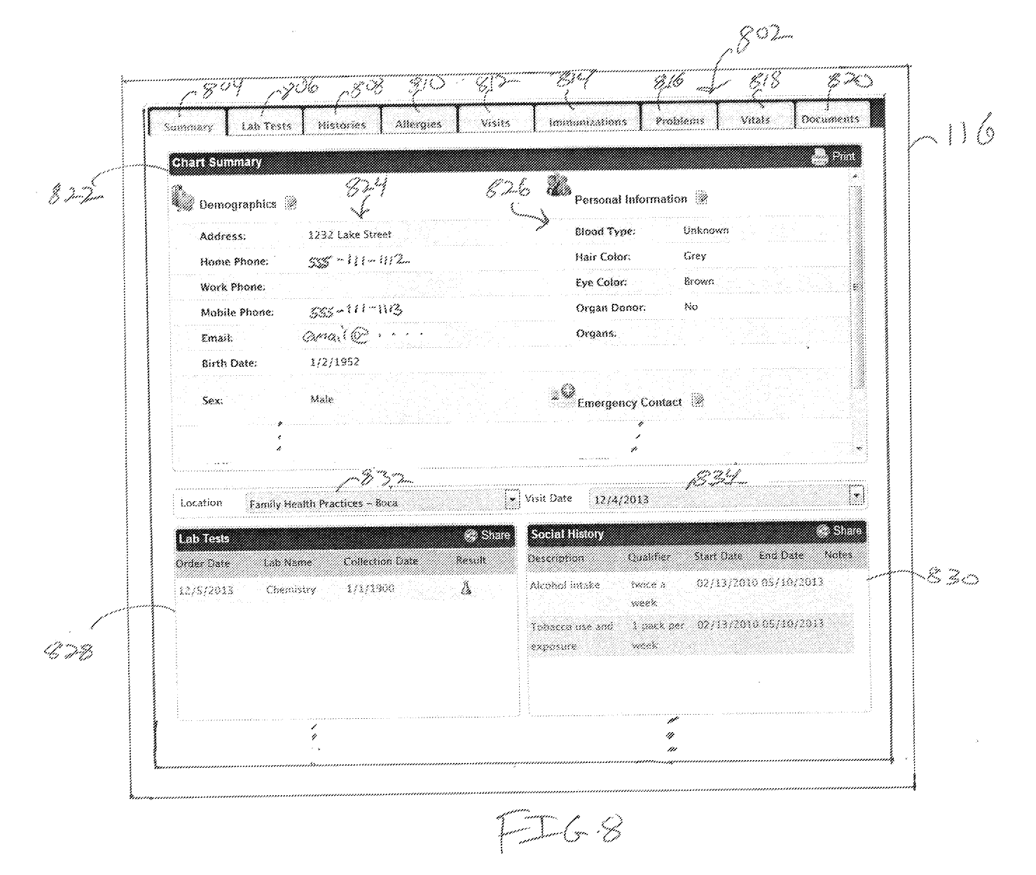

As discussed above, the patient portal 114 is a health care-related website and/or online application or service that allows patients to securely manage and view their health information created by one or more health care providers (e.g., physicians and hospitals) and/or provided by the patient. A patient is able to log into the patient portal from a web browser and/or an application residing on his/her user system 108. After the patient enters his/her login credentials and has been authenticated by the portal manager 118, the data presenter 204 presents a personalized portion 702 of the interactive environment 116 to the patient, as shown in FIG. 7.

The personalized portion 702 of the interactive environment 116 shown in FIG. 7 comprises a first section 704 that identifies the patient. This section 704 comprises the patient's name, picture, and/or the like. This section 704 also comprises various portal management options such as an account settings option 706, an option 708 to view the patient's health record, an option 710 to view, download, and/or transmit the patient's health-related records, and an option 712 (if applicable) to upgrade to a premium paid service or downgrade from the premium service to a free service. The account settings option 706 allows the patient to view/edit various account setting such as passwords, address information, phone information, email addresses, payment information, and/or the like. The health record option 708 allows the patient to view all of his/her health-related information. The view, download, and/or transmit option 710 allows the patient to view, download, customize, and/or transmit individual health-related records entered by the patient, integrated partners, and non-integrated entities. This option 712 is discussed in greater detail below.

The personalized portion 702 of the interactive environment 116 further comprises a second section 714 that displays various premium services offered to the patient. Examples of premium services include (but are not limited to) a drug information center, a health information library, an In Case of Emergency (ICE) program, a pharmacy locator, a medical ID bracelet ordering option, a medical ID card, an online blood lab option, prescription discount card, and/or the like. It should be noted that services and options that are identified as premium services/options in some embodiments can be free services in other embodiments, and vice versa.

FIG. 7 further shows a third section 716 of the interactive environment 116 comprising one or more selectable options that allow the patient to view and interact with various different types of health-related data. Examples of selectable options include (but are not limited to) a home option 718, a clinical summary option 720, a messages option 722, an appointments option 724, a medications option 726, a referrals option 728, a premium services option 730, a marketplace option 732, a manage doctors option 734, an emergency contacts option 736, a share my records option 738, a medical portfolio option 740, and a digital file cabinet option 742. One or more of these options can be provided to the patient as a paid-for premium service. In one embodiment, when the patient views health-medical data 126 or records 128 made available by a facility or provider, the portal manager 118 records this interaction in the log section of the user profile 120. The log data can identify the data/record interacted with, the interaction performed by the user, the date and/or time of interact, an identification of the facility and/or provider associated with the data/record, and/or the like. This log data can also be maintained within a facility profile 122, subscriber profile 124, a profile for the provider, and/or the like.

When the patient selects the home option 718, a home area 744 of the interactive environment 116 is populated with various types of information and options. In particular, the home option 718 provides a patient customizable view of his/her health-related data. For example, the patient is able to select one or more widgets from a list of widgets to be displayed in his/her home section of the interactive environment 116. The patient is also able to place each of these widgets at a desired location within the home section of the interactive environment 116. The portal manager 116 records the patient's widget selections and their positioning information within the preferences section of the patient's user profile 120. It should be noted that default widgets can also be displayed and positioned at default locations. Also, patient selected widgets can be placed at default locations as well.

In one embodiment, each widget is associated with a different type of health-related information. For example, a first widget 746 comprises provider visit data, a second widget 748 comprises family history data, a third widget 750 comprises medication data, a fourth widget 752 comprises past medical history data, a fifth widget 754 comprises patient health-medical problems, and a sixth widget 756 comprises immunization data. Other examples of widgets include (but are not limited to) provider appointment data, social history data, lab test data, provider statement/billing data, vitals data, insurance data, allergy data, provider-based documents, plan of care data, medical procedure data, and/or the like.

The data presenter 204 populates each displayed widget based on the health-medical data 126 extracted from the received communications associated with the patient and/or associated records 128. For example, the data presenter 204 searches the health-medical data 126, records, 128, and/or profiles 120, 122, 124 to identify the appropriate data for each widget. In this embodiment, the portal manager 114 associates the health-medical data 126 and records 128 with a given data type such visits, family history, medications, etc. The data types can be already associated with the health-medical data and records in the communication received from an EHMS, facility, and/or patient. The portal manager 114 can also be trained to analyze the health-medical data 126 (and records 128) and recognize the data type from this analysis. The data presenter 204 identifies the health-medical data 126 (and records) comprising a data type corresponding to the data type of each widget, and populates the various fields within each widget with the appropriate health-medical data 126 (or records 128). Also, the patient is able to select a given entry within a widget to view additional details of that particular entry. Also, some entries such as lab result entries can be selected to have an image, a document (e.g., lab result document), and/or the like displayed to the patient.

In one embodiment, the patient selects source type 758 (or a provider/facility name) so that the data displayed in a widget is data provided by an integrated partner, a non-integrated partner, or entered by the patient. In the example shown in FIG. 7, the patient has selected the source type of “Patient Entered”. Therefore, when the data presenter 204 is searching the health-medical data 126, records, 128, and/or profiles 120, 122, 124 to identify the appropriate data for each widget the presenter 204 identifies data with a source type identifier of “Patient Entered”. The source type option 758 allows the patient to view and identify which data was provided by a given source type. Each widget can comprise a field that identifies the source type of each entry within the widget. Also, different widgets can be displayed based on the source type selected by a patient. A visit date option 760 can also be provided to the patient that allows the patient to select a provider visit date. The data presenter 204 searches the health-medical data 126, records, 128, and/or profiles 120, 122, 124 to identify data that is associated with the specified visit date. The data presenter 205 then populates the widgets with the identified data.

Each widget can be associated with one or more widget options such as an add option 762, a share option 764, and a hide option 766. The add option 762 allows the patient to add one or more entries into the widget. For example, if the patient selects an add option for the medications widget 750, a form is presented to the patient that allows him/her to add medication related information such as medication name, when the patient first starting taking the medication or stopped taking it, the number of refills left, etc. The share option 764 allows the patient to indicate whether the information within or associated the widget can be shared with someone or is to be kept hidden/confidential (i.e., not shared or displayed to parties other than the patient). The patient is able to select specific entries in the widget and indicate if these entries are sharable or confidential, or can have the sharable/confidential property be applied to all entries within the widget. The portal manager 118 updates the records 128 comprising the health-medical data 126 within each widget or annotates the health-medical data 126 with an identifier or flag indicating whether the data 126 has been marked as sharable or hidden. If the patient has not specified a sharable/confidential property for data 126, the portal manager 118 can apply a default property to the data 126. Also, each entry within a widget can be associated with a status field indicating whether the entry (or its associated data/record) is sharable or to be kept hidden/confidential.

In another embodiment, the share option 764 allows the patient to select one or more parties to share the information (either all entries or only entries marked as sharable) with. For example, the patient can provide recipient details such as mailing address, messaging address, fax number, etc. of a recipient. Alternatively, the patient selects a recipient from a list of recipients such as a provider list. The portal 114 then transmits the selected data to the recipient using one or more transmission mechanisms such as those discussed above. Alternatively, the recipient can be notified that a message is waiting to be downloaded by the recipient. The hide option 766 allows the patient to hide a given widget from view. It should be noted that one or more of the widgets options can be source type dependent. For example, the add option 762, in one embodiment, is not provided to the patient for one or more widgets that are displaying data with an “integrated partner” source type; however, this is not required.

In addition to the above, the home are 744 of the interactive environment 116 also provides the patient with a send message option 768, an appointments option 770, a refill medication option 772, and a request referral option 774. The send message option 774 allows the patient to send one or more messages to a given provider. For example, a form is presented to the patient that allows the patient to select or input a facility, a given provider, a message subject, a message priority, and/or the like. The patient can also enter a specific message into the form. Once the patient has created the message the portal 114 securely sends the message to the recipient or notifies the recipient that a message is waiting, as discussed above. The appointments option 770 allows the patient to request an appointment for a given provider. The refill medication option 772 allows the patient to request a refill for one or more medications. The referral request option 774 allows the patient to request a referral from his/her physician. It should be noted that the home area 744 of the interactive environment 116 is not limited to the examples discussed above.

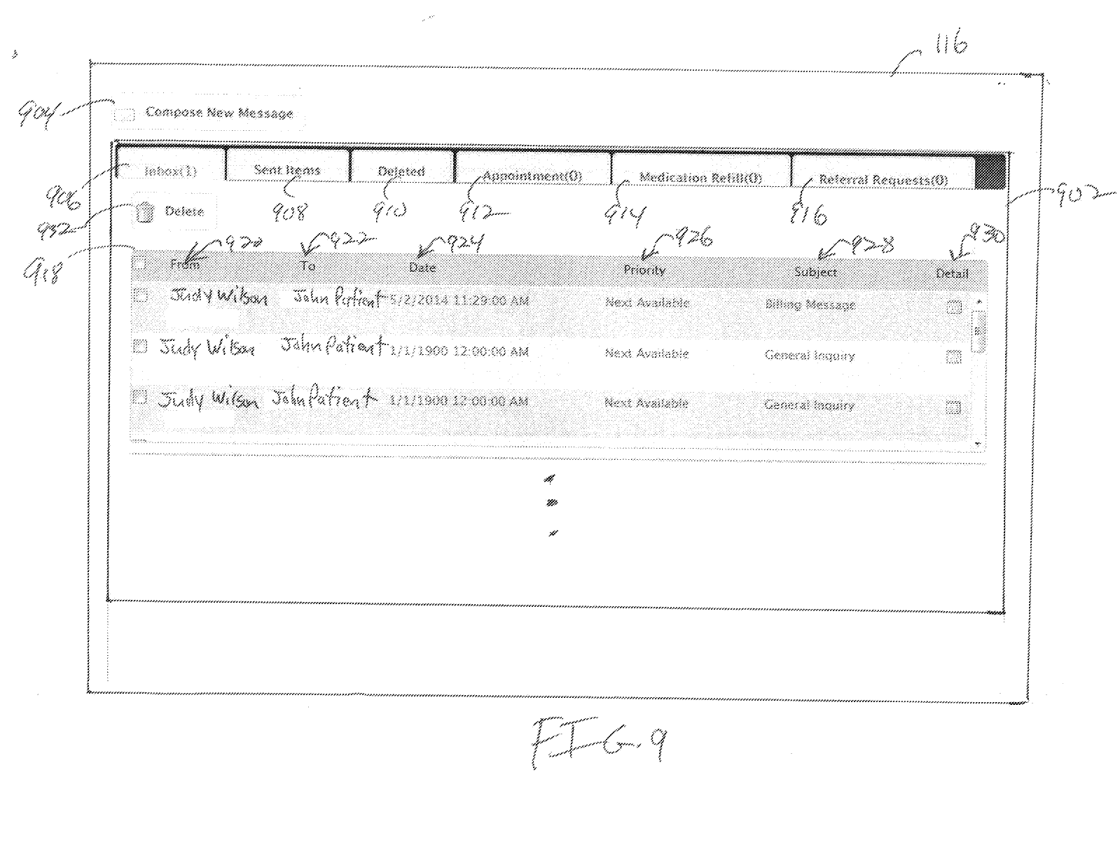

FIG. 8 shows one example of a clinical summary section 802 of the interactive environment 116. This section 802 is presented to the patient within the interactive environment 116 when the patient selections the clinical summary option 720. However, this section or any other section can be set as the patient's default section that is displayed to the patient when he/she logs into the portal 114. The clinical summary section 802 comprises a plurality of viewing options such as a summary option 804, a lab tests option 806, a histories option 808, an allergies option 810, a visits option 812, an immunizations option 814, a problems option 816, a vitals option 818, and a documents option 820.

The summary option 804 presents a chart summary 822 to the patient. The chart summary 822 is populated by the data presenter 204 with various demographic 824 and personal information 826 associated with the patient. The demographic and personal data 824, 826 is obtained by the data presenter 204 from the user profile 120, health-medical data 126, and/or records 128 associated with the patient. The clinical summary section 822 optionally displays one or more widgets 828, 830 similar to those discussed above with FIG. 7 along with one or more of the widget options. The patient is also presented with a source type option 832 and a visit date option 834 similar to those discussed above with respect to FIG. 7.

When the patient selects the lab tests option 806, the data presenter 204 updates the clinical summary section 802 to display lab tests results records/data to the patient. Information such as lab name, source, provider, order date, collection date, report date, review date, and results are displayed to the patient. The patient is able to select the results portion to view the actual lab results. The patient is also presented with a source type option and a visit date option similar to those discussed above with respect to FIG. 7. The patient selects a given source type and/or a visit date to view lab results records provided by the selected source and/or for a given visit date. The patient is also presented with one or more data options such as an add option and a share option similar to the widgets options discussed above. The add option allows the patient to add additional lab results to his/her health-related data 126. The share option allows the patient to associate a sharable/confidential property to all lab results entries or specific entries, as discussed above.

The histories option 808 presents history-related information such as social history information, family history information, and past medical history information to the patient. Social history information such as description, qualifier, code value, start date, end date, notes, and details are displayed to the patient. The patient is able to select the details area to view additional details for the given entry. Family history information such as relationship, condition description, notes, and details are displayed to the patient. The patient is able to select the details area to view the additional details for the given entry. Past medical history information such as date, diagnosis/disease, notes, and details are displayed to the patient. The patient is able to select the details area to view the additional details for the given entry.

The patient is also presented with a source type option and a visit date option similar to those discussed above with respect to FIG. 7. The patient selects a given source type and/or a visit date to see history records provided by the selected source type and/or for a given visit date. The patient is also presented with one or more data options such as an add option and a share option similar to the widgets options discussed above. The add option allows the patient to add additional history data to his/her health-related data 126. The share option allows the patient to associate a sharable/hidden property to all history data entries or specific entries, as discussed above. The share option can also allow the patient the designate one or more parties to share the data with.

The allergies option 810 displays various allergy information/records to the patient in the clinical summary section 802. Allergy information such as effective date, allergen type, allergen, reaction, notes, status, and details are displayed to the patient. The patient is able to select the details area to view the additional details for the associated entry. The patient is also presented with a source type option and a visit date option similar to those discussed above with respect to FIG. 7. The patient selects a given source type and/or a visit date to see allergy information/records provided by the selected source and/or for a given visit date. The patient is also presented with one or more data options such as an add option and a share option similar to the widgets options discussed above. The add option allows the patient to add additional allergy information/records to his/her health-related data 126. The share option allows the patient to associate a sharable/confidential property to all allegery entries or specific entries, as discussed above. The share option can also allow the patient the designate one or more parties to share the data with.

The visits option 812 displays various provider/facility visit information or records to the patient in the clinical summary section 802. Visit information such as date of visit, visit reason, provider, location, and details are displayed to the patient. The patient is able to select the details area to view the additional details for the associated entry. The patient is also presented with a source type option and a visit date option similar to those discussed above with respect to FIG. 7. The patient selects a given source type and/or a visit date to see visit information/records provided by the selected source and/or for a given visit date. The patient is also presented with one or more data options such as an add option and a share option similar to the widgets options discussed above. The add option allows the patient to add visit information/records to his/her health-related data 126. The share option allows the patient to associate a sharable/confidential property to all visit entries or specific entries, as discussed above. The share option can also allow the patient the designate one or more parties to share the data with.

The immunizations option 814 displays various immunization information/records to the patient in the clinical summary section 802. Immunization information such as immunization date, vaccine administered, and details are displayed to the patient. The patient is able to select the details area to view the additional details for the associated entry. The patient is also presented with a source type option and a visit date option similar to those discussed above with respect to FIG. 7. The patient selects a given source type and/or a visit date to see immunization information/records provided by the selected source and/or for a given visit date. The patient is also presented with one or more data options such as an add option and a share option similar to the widgets options discussed above. The add option allows the patient to add immunization information/records to his/her health-related data 126. The share option allows the patient to associate a sharable/confidential property to all immunization entries or specific entries, as discussed above. The share option can also allow the patient the designate one or more parties to share the data with.

The problems option 816 displays various problems information/records to the patient in the clinical summary section 802. Problem information such as onset date, description, notes, status, and details are displayed to the patient. The patient is able to select the details area to view the additional details for the associated entry. The patient is also presented with a source type option and a visit date option similar to those discussed above with respect to FIG. 7. The patient selects a given source type and/or a visit date to see problems information/records provided by the selected source and/or for a given visit date. The patient is also presented with one or more data options such as an add option and a share option similar to the widgets options discussed above. The add option allows the patient to add problems information/records to his/her health-related data 126. The share option allows the patient to associate a sharable/confidential property to all problem entries or specific entries, as discussed above. The share option can also allow the patient the designate one or more parties to share the data with.

The vitals option 818 displays various problems information/records to the patient in the clinical summary section 802. Vitals-based information such as observation date, blood pressure, weight, height, BMI, and details are displayed to the patient. The patient is able to select the details area to view the additional details for the associated entry. The patient is also presented with a source type option and a visit date option similar to those discussed above with respect to FIG. 7. The patient selects a given source type and/or a visit date to see vitals-based information/records provided by the selected source and/or for a given visit date. The patient is also presented with one or more data options such as an add option and a share option similar to the widgets options discussed above. The add option allows the patient to add vitals-based information/records results to his/her health-related data 126. The share option allows the patient to associate a sharable/confidential property to all lab results entries or specific entries, as discussed above.

The documents option 820 displays various documents information/records to the patient in the clinical summary section 802. Documents information such as date, document description, and notes details are displayed to the patient. The patient is able to select the entry to view the actual document associated therewith. The patient is also presented with a source type option and a visit date option similar to those discussed above with respect to FIG. 7. The patient selects a given source type and/or a visit date to see document information/records provided by the selected source and/or for a given visit date. The patient is also presented with one or more data options such as an add option and a share option similar to the widgets options discussed above. The add option allows the patient to add document information/records to his/her health-related data 126. The share option allows the patient to associate a sharable/confidential property to all document entries or specific entries, as discussed above. The share option can also allow the patient the designate one or more parties to share the data with.

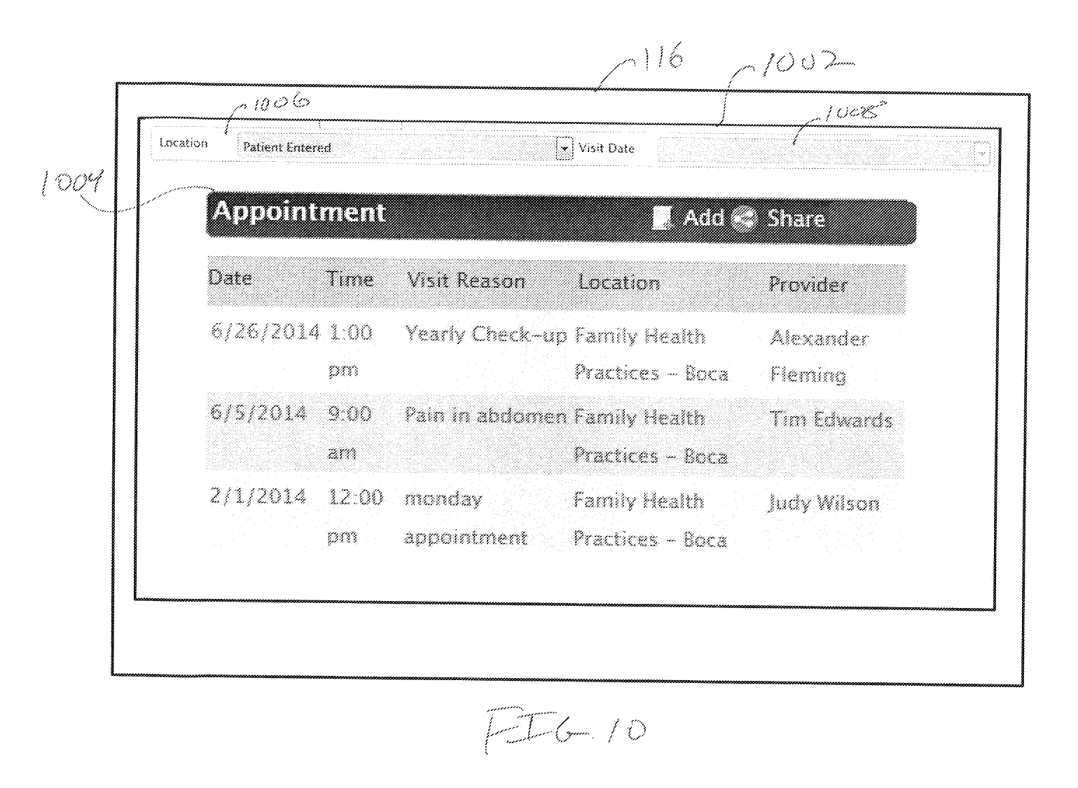

When the portal manager 118 detects that the patient has selected the messages option 722 of the home area 744, the data presenter 204 displays a messaging section 902 to the patient in the interactive environment 116 as shown in FIG. 9. The messaging section 902 displays various messages sent to the patient from providers, facilities, and/or the like. The messaging section 902 also allows the patient to create and manage messages. In one embodiment, the messaging section 902 comprises a compose message option 904 that allows the patient to create one or more messages to be sent to a provider, facility, and/or the like.

The messaging section 902 also displays one or more selectable options such as an inbox option 906, a sent items option 908, a deleted option 910, an appointments option 912, a medication refill option 914, and a referral request option 916. FIG. 9 shows one example of the messaging section 902 after the patient has selected the inbox option 906. When the inbox option 906 is selected, a list of received messages 918 is displayed to the patient. Each entry in this list 918 identifies the sender 920, the recipient 922, the date and time the message was received 924, the priority of the message 926, the subject of the message 928, and details of the message 930. The patient is able to select an entry in the list 918 to view the received message and its contents. The patient can also select an option 932 to delete one or more of the messages.

The sent items option 908 displays a list of message sent from the patient to a given recipient. The deleted option 910 displays a list of deleted messages to the patient. The appointments option 912 displays a list of messages sent by the patient for appointment requests and any responses to these messages. The medication refill option 914 displays a list of messages sent by the patient for medication refill requests and any responses to these messages. The referral request option 916 displays a list of messages sent by the patient for referral requests and any responses to these messages.

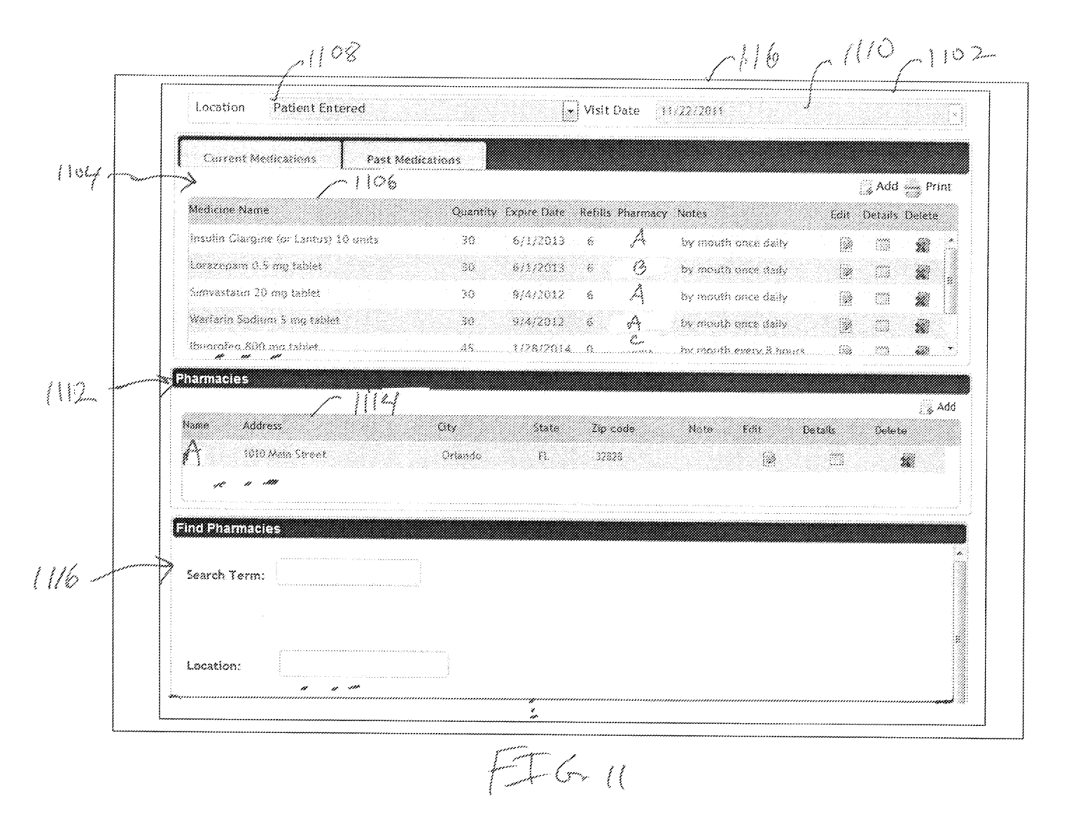

When the portal manager 118 detects that the patient has selected the appointments option 724 of the home area 744, the data presenter 204 displays an appointments section 1002 to the patient in the interactive environment 116 as shown in FIG. 10. The appointments section 1002 displays a list 1004 comprising entries associated with one or more appointments previously held (or currently held) by the patient. Appointment data such as appointment date, appointment time, visit reason, appointment location, and provider are displayed for each entry in the list 1004. The patient is also presented with one or more data options such as an add option and a share option similar to the widgets options discussed above. The add option allows the patient to add appointment information/records to his/her health-related data 126. The share option allows the patient to associate a sharable/confidential property to all appointment entries or specific entries, as discussed above. The share option can also allow the patient the designate one or more parties to share the data with. The patient is also presented with a source type option 1006 and a visit date option 1008 similar to those discussed above with respect to FIG. 7.

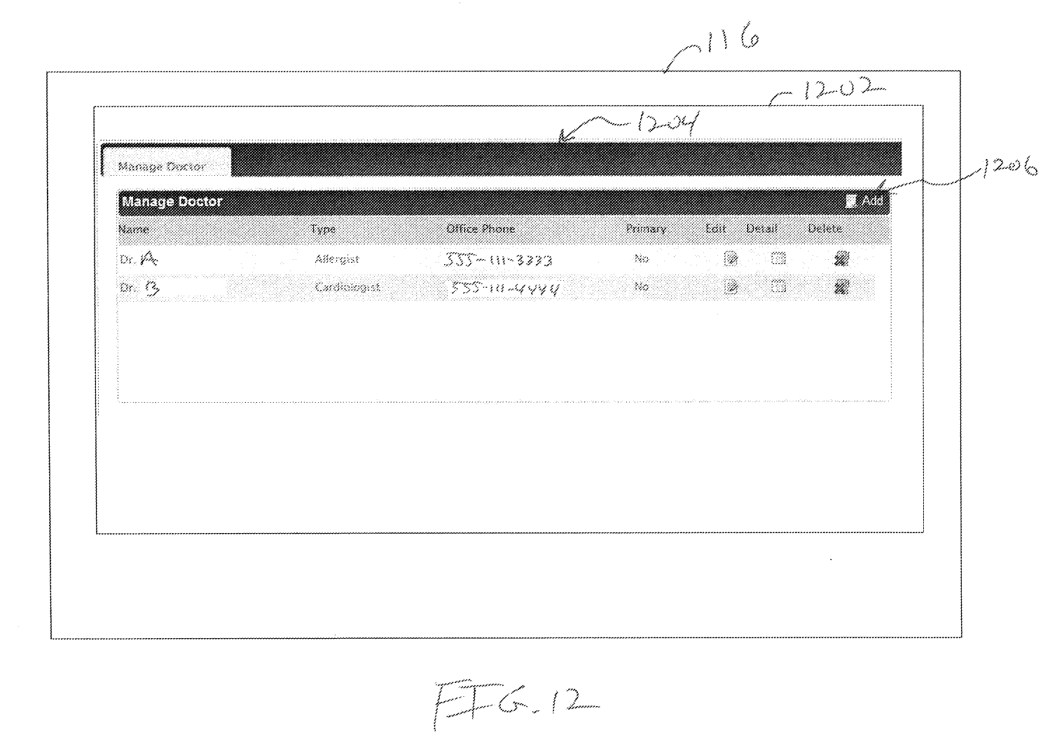

The medications option 726 of the home area 744 presents the patient with a medications section 1102 in the interactive environment 116 as shown in FIG. 11. A first portion 1104 of the medications section 1102 displays a list 1106 of current and past medications for the patient. Information such as medicine name, quantity, expiration date, refills, pharmacy, notes, and details are provided to the patient for each entry in the list 1106. The patient is able to select the details area to view additional details for the associated entry. The patient is able to select an option to edit the information for a given medication, and can also delete an entry from the list 1106. The patient is also presented with a source type option 1108 and a visit date option 1110 similar to those discussed above with respect to FIG. 7.

A second portion 1112 of the medications section 1102 displays a list 1114 of pharmacies associated with the patient. Information such as pharmacy name, address, city, state, zip code, notes, and details is displayed to the patient. The patient is able to select the details area to view additional details for the associated entry in the list 1114. The patient is able to select an option to edit the information for a given pharmacy, and can also delete and entry from the list 1106. A third portion 1116 of the medications section 1102 is also displayed to the patient. This portion 1116 allows the patient to search for pharmacies using various search criteria.

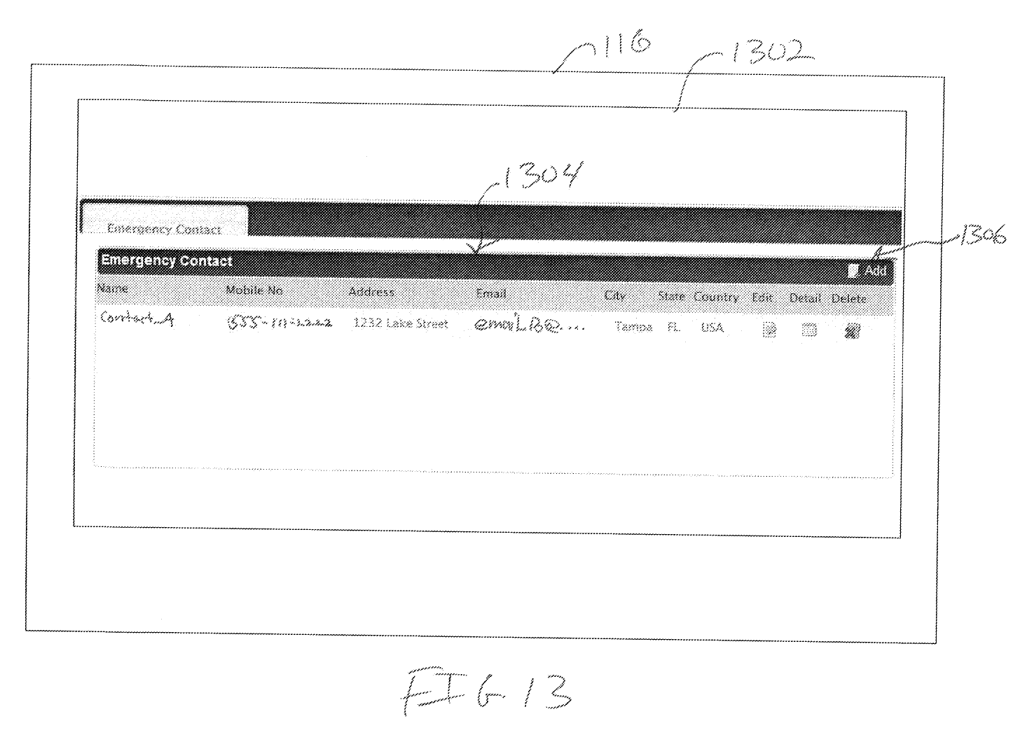

The referrals option 728 of the home area 744 displays a referrals section (not shown) to the patient in the interactive environment 116. The marketplace option 732 displays a marketplace section (not shown) to the patient in the interactive environment 116. The marketplace section allows the patient to check drug interactions and perform other tasks. The manage doctors option 734 of the home area 744 presents the patient with a manage doctors section 1202 in the interactive environment 116 as shown in FIG. 12. The manage doctors section 1202 comprises a list 1204 of doctors currently associated with the patient. This list 1204 displays information such as doctor name, type, office phone, whether the doctor is a primary care physician, and details to the patient. The patient is able to select the details area to view additional details for the associated entry in the list 1204. The patient is able to select an option to edit the information for a given doctor, and can also delete an entry from the list 1204. The patient is also presented with an add option 1206 that allows the patient to add one or more doctors to his/her health-related data 126 or records 128.

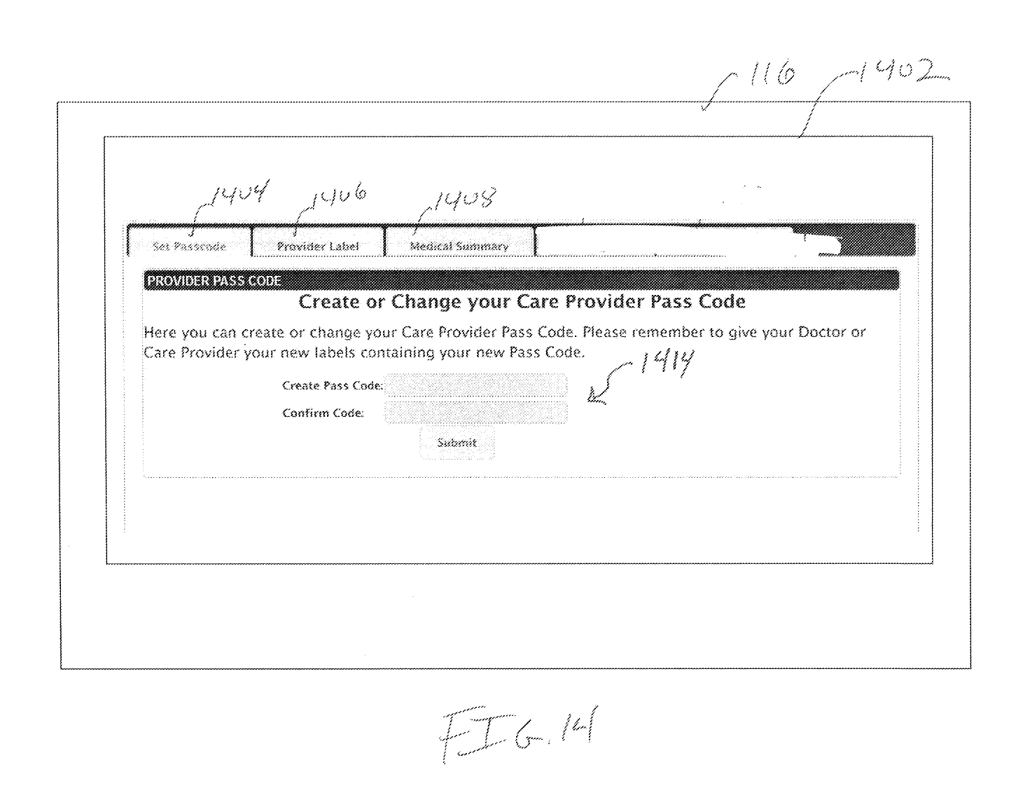

The emergency contacts option 736 of the home area 744 presents the patient with an emergency contacts section 1302 in the interactive environment 116 as shown in FIG. 13. The emergency contacts section 1302 comprises a list 1304 of emergency contacts currently associated with the patient. This list 1304 displays information such as name, mobile number, address, email, city, state, country, and details to the patient. The patient is able to select the details area to view additional details for the associated entry in the list 1344. The patient is able to select an option to edit the information for a given doctor, and can also delete an entry from the list 1204. The patient is also presented with an add option 1306 that allows the patient to add one or more emergency contacts to his/her health-related data 126 or records 128.

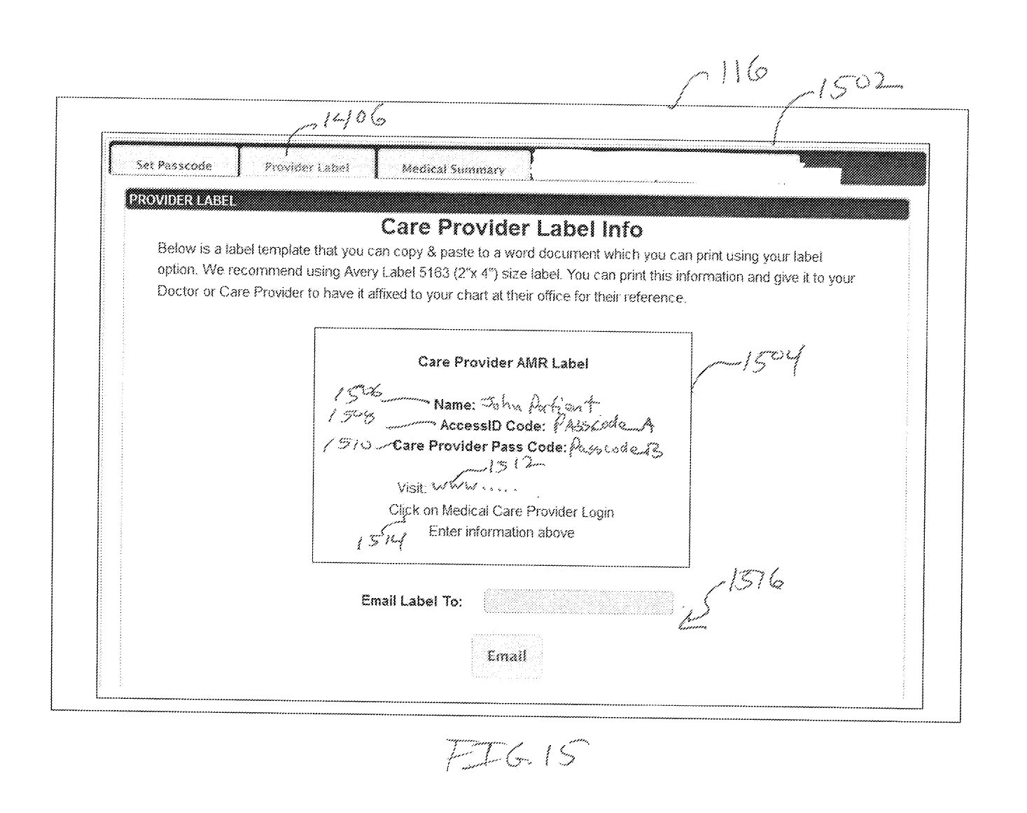

The share my records option 738 of the home area 744 presents the patient with a share records section 1402 in the interactive environment 116 as shown in FIG. 14. The share records section 1402 comprises a plurality of options such as a set passcode option 1404, a provider label section 1406, and a medical summary section 1408. The set passcode section 1404 comprises an option 1414 that allows the patient to create a change a care provider pass code. This passcode allows the care provider to log into the patient portal 114 and view the health-medical data 126 or records 128 associated with the patient. It should be noted that, in one embodiment, any data 126 or records 128 marked by the patient as being confidential/hidden are not displayed to the care provider when he/she logs into the patient portal using the passcode created by the patient.

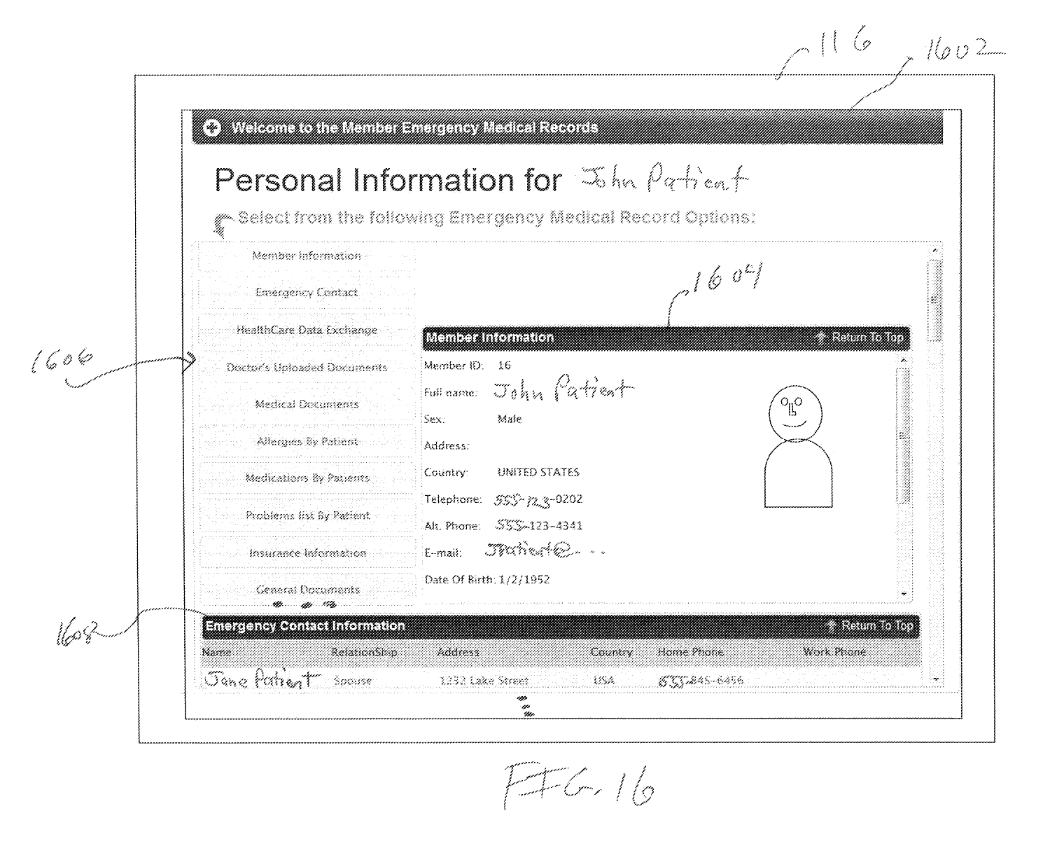

The provider label option 1406 displays a care provider label section 1502 to the patient in the interactive environment 116 as shown in FIG. 15. When this option 1406 is selected, the portal manager 1408 automatically generates a label 1504 (or retrieves a previously generated label) that can be printed out and given to the provider by the patient, and/or automatically sent to the provider by the portal. The label 1504, in one embodiment comprises an identification 1506 of the patient; a login passcode 1508 associated with the patient, which can be different or the same as the patient's login password; and a passcode 1510 generated for the care provider. The label 1504 also comprises a URL 1512 for the patient portal 114, and instructions 1514 on how to log into the portal 114. The care provider label section 1502 also comprises an option 1516 that allows the patient to enter an email address of their provider to have the portal 114 automatically send the label 1504 to the provider.

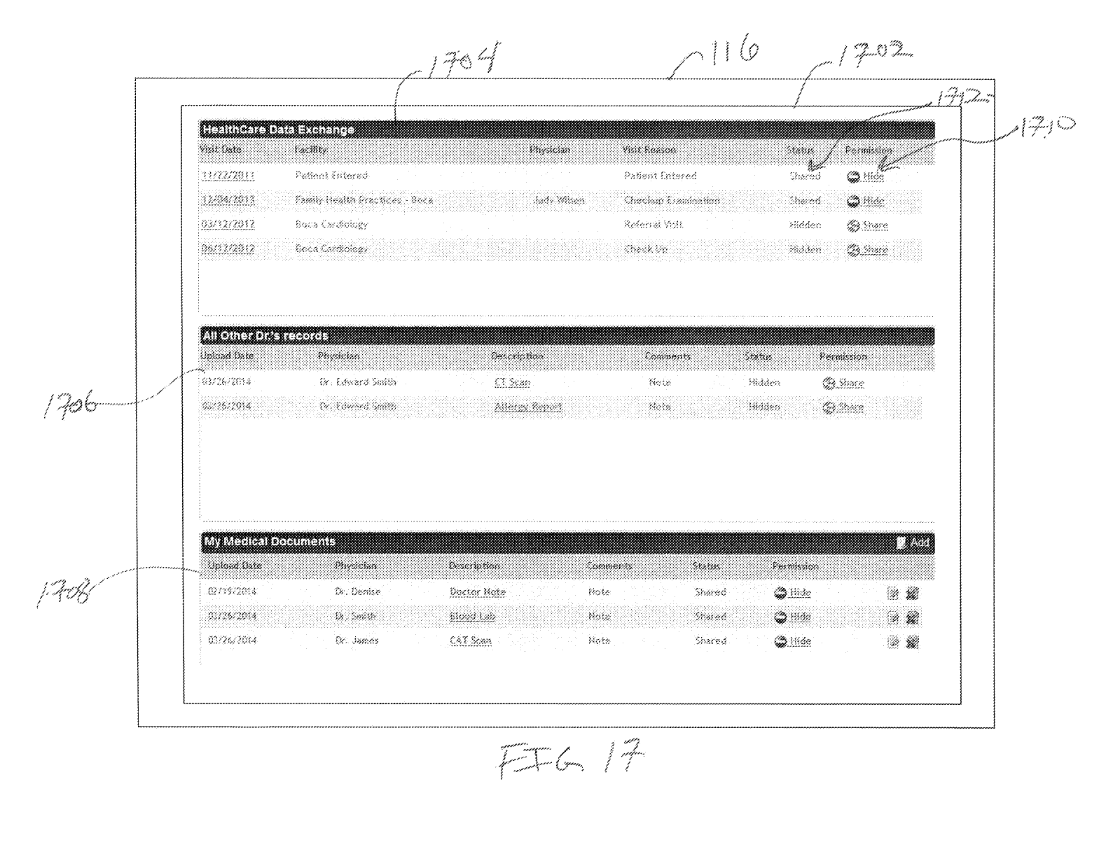

The medical summary option 1408 provided in the share my records section 1402 displays an emergency records section 1602 to the patient and a provider in the interactive environment 116 as shown in FIG. 16. This section 1602 displays personal and demographic information 1604 associated with the patient and one or more emergency records options 1606 to a recipient. In one embodiment, the patient or provider is able to select a record option 1606 to have the corresponding record displayed. For example, if the patient or provider selects the emergency contact record option the corresponding emergency contact record 1608 is displayed within the interactive environment 116. In one embodiment, when a care provider logs into the portal 114 utilizing the information on the provider label 1502, the emergency record information of FIG. 16 is presented to the provider. However, other health-medical data 126 and records 128 can be displayed to a provider as well. Alternatively (or in addition to), these emergency records are presented to a health care provider in an emergency situation associated with the patient. In one embodiment, only records/data associated with a sharable property are allowed to be viewed by parties other than the patient, as discussed above.

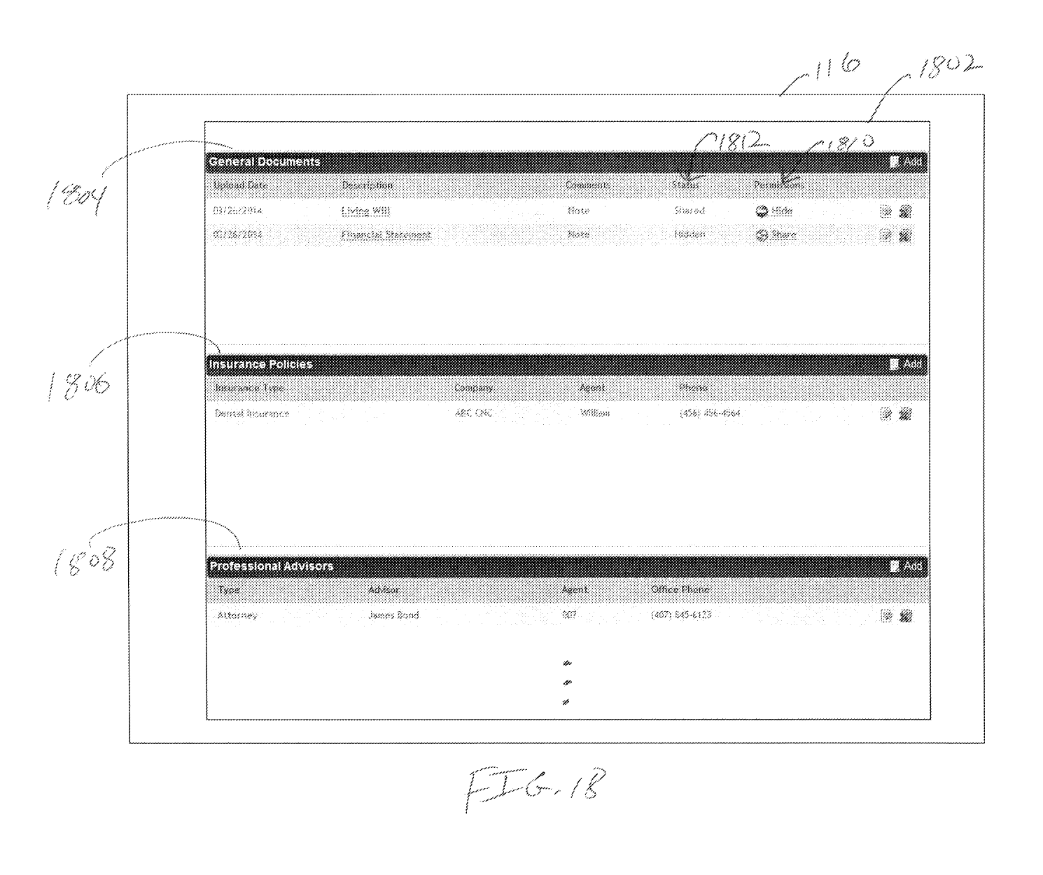

The medical portfolio option 740 of the home area 744 displays a medical portfolio section 1702 to the patient in the interactive environment 116 as shown in FIG. 17. This section 1702 groups and presents the health-medical data 126 and records 128 associated with the patient based on their assigned source type. For example, the data presenter 204 displays a first area 1704 comprising health-medical data 126 and records 128 from integrated partners, a second area 1706 comprising health-medical data 126 and records 128 from non-integrated entities, and a third area comprising health-medical data 126 and records 128 provided by the patient. The integrated partner entries comprise information such as visit date, facility, physician, and reason for visit. The patient is able to select an entry in this area 1704 to view additional details for the record/data represented by the entry.

The non-integrated entity entries comprise information such as upload data, physician, description, and comments. The patient is able to select an entry in this area 1706 to view additional details for the record/data represented by the entry. The patient entered entries comprise information such as upload date, physician, description, and comments. The patient is able to select an entry to view additional details for the record/data represented by the entry. It should be noted that each of these areas 1704, 1706, 1708 can comprise additional information as well.

In one embodiment, each entry in the integrated partner area 1704, the non-integrated entity area 1706, and the patient area 1708 can be associated with a sharable or hidden (confidential) property similar to that discussed above. The patient is able to select an option 1710 to change the permission of the entry (and its health-medical data 126 or record 128) to either shared or hidden (confidential). A status field 1712 displays the current sharable/hidden status of the entry and its health-medical data 126 or record 128. As discussed above, health-medical data 126 and records 128 associated with a shared property are displayed to providers when they access the patient's data, receive messages comprising the patient's data, download documents comprising the patient's data, and/or the like. However, health-medical data 126 and records 128 associated with a hidden/confidential property are not displayed to providers they access the patient's data, receive messages comprising the patient's data, download documents comprising the patient's data, and/or the like. For example, when a provider logs into the portal 114 to view a patient's data; when a message is being generated with the patients date; or a document is being downloaded with the patient's data, the data presenter 204 analyzes the health-medical data 126 and records 128 to be viewed, sent, or downloaded and identifies the sharable/hidden flag associated therewith. Any health-medical data 126 and records 128 with a hidden tag are prevented from being displayed or included within a message or document.

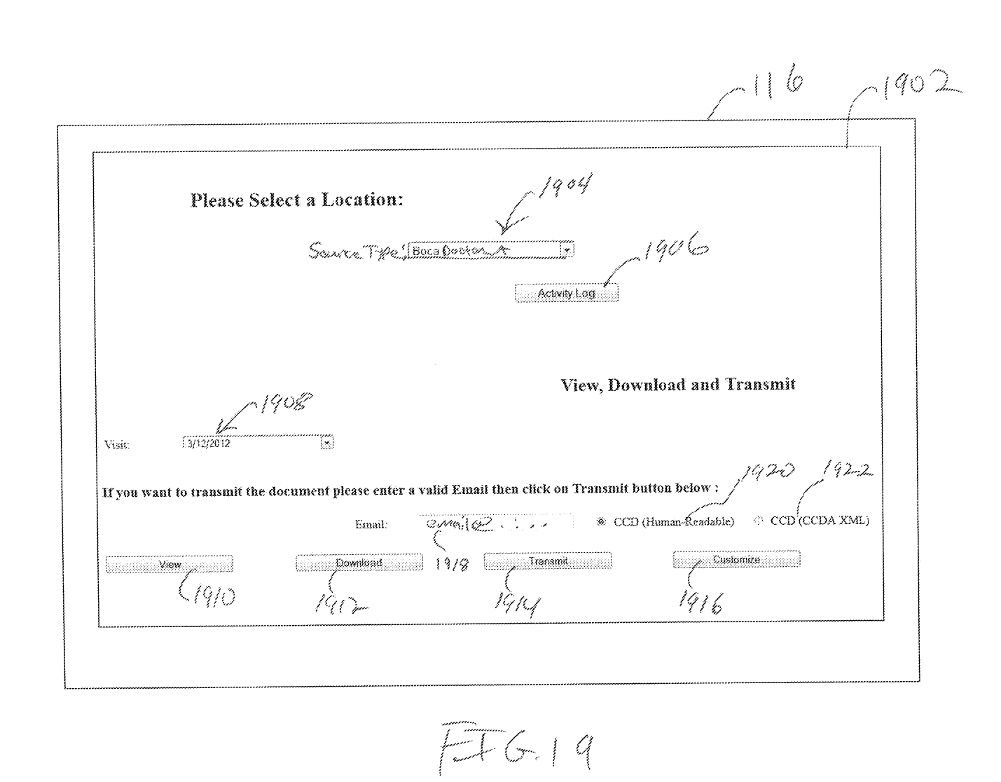

The digital file cabinet option 742 of home area 744 presents the patient with a digital file cabinet section 1802 in the environment 116 as shown in FIG. 18. This section 1802 displays one or more areas 1804, 1806, 1808 associated with various types of documents. For example, FIG. 18 shows a first area 1804 comprising general document information, a second area 1806 comprising insurance policy document information, and a third area 1808 comprising professional advisor document information. The patient is able to select on an entry within one of these areas 1804, 1806, 1808 and view the document associated with the entry. The patient can also select a permissions option 1810 to allow sharing of the document and its data to hide or keep the document and its information confidential, as discussed above with respect to FIG. 17. A status indicator 1812 identifies whether a given document and its information is sharable or hidden.

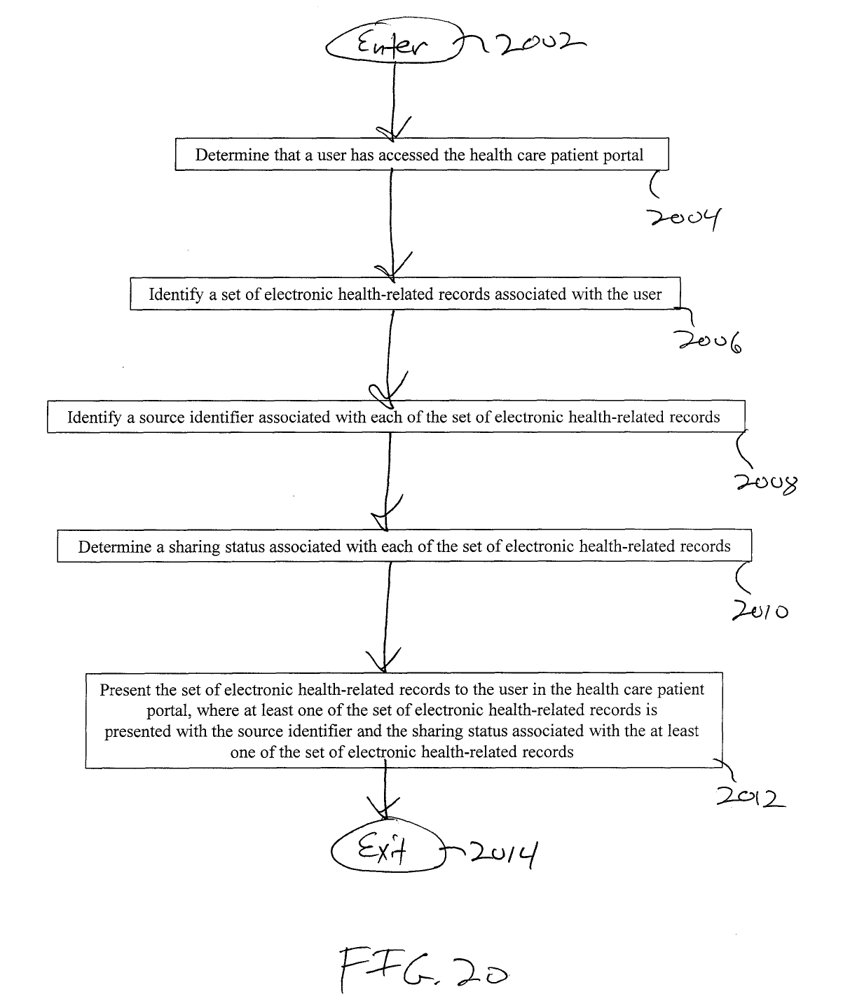

When the patient selects the view, download, and transmit option 710 of the home area 744 a view, download, and transmit section 1902 of the interactive environment 116 is displayed to the patient as shown in FIG. 19. In this section 1902, the patient selects a source type 1904 for the date of interest, which can include a selection of all source types. As discussed above, the source type identifies data as being either provided by an integrated partner, a non-integrated entity, or the patient herself. The patient can also be presented with a list comprising each integrated partner and/or non-integrated entity for selection by the patient. An activity log 1906 is also provided to the patient that displays the various activities performed by the patient or a provider (e.g., view health-medical data or records, transmit health-medical data or records, etc.), the date and time of the activity, and/or the like.

In one embodiment, the patient also provides visit criteria 1908 specifying a given visit, range of visits, and/or all available visits. The patient further selects an a first option 1910 to view the record(s) corresponding to the source type and visit selections; a second option 1912 to download the record(s); a third option 1914 to transmit the record(s); and/or a fourth option 1916 to customize the record(s) for viewing, downloading of transmitting the record(s). This customization option allows the patient to select which data or sections in the record(s) are viewed, downloaded, and/or transmitted. If the patient selects the option to transmit the data or record(s) the patient provides or selects the messaging address 1918 of the recipient. The patient can also indicate whether the viewed, downloaded, and/or transmitted record (or data) is to be a CCD 1920 in human-readable format, or a CCDA XML based CCD 1922.

For example, if the patient selected a given provider from the source type and a specific visit date, the data presenter 204 analyzes the health-medical data 126 or records associated with the patient to identify a set of data or record(s) received from this specific provider for the specified visit date. This identified record is then displayed to then presented to the patient on his/her display, downloaded to the patient's system 108, and/or automatically transmitted to the recipient specified by the patient. It should be noted that any portions of the identified data 126 or record 128 marked as being hidden are not included in any displayed, sent, or downloaded data/record being viewed by any party other than the patient.

Operational Flow Diagrams

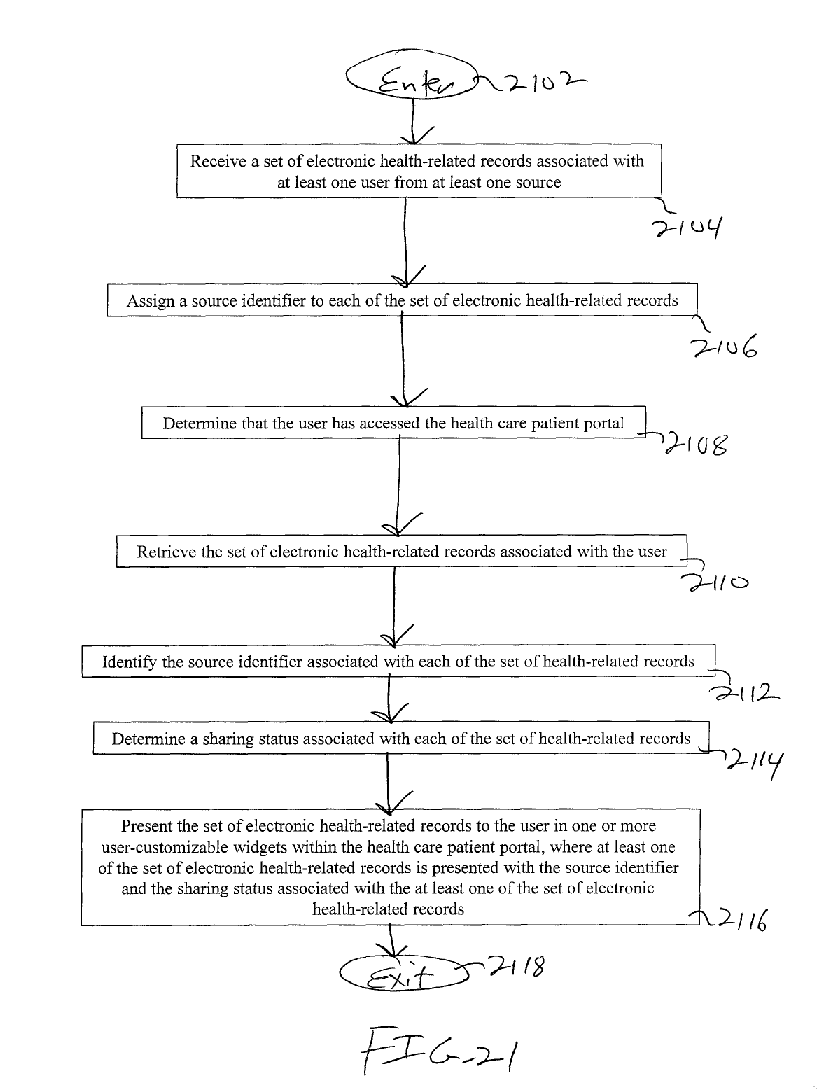

FIG. 20 is an operational flow diagram illustrating one example of an overall process for managing access to patient health-related information in a health care patient portal. The operational flow of FIG. 20 beings a step 2002 and flows directly to step 2004. The portal manager 118, at step 2004, determines that a user has accessed the health care patient portal 114. The portal manager 118, at step 2006, identifies a set of electronic health-related records 128 associated with the user. The portal manager 118, at step 2008, identifies a source identifier associated with each of the set of electronic health-related records 128. The source identifier is associated with an entity that provided the electronic health-related record to the health care patient portal 114.

The portal manager 118, at step 2010, determines a sharing status associated with each of the set of electronic health-related records 128. The sharing status indicates that the associated electronic health-related record 128 is one of sharable and non-sharable with an entity other than the user. The portal manager 118, at step 2012, presents the set of electronic health-related records 128 to the user in the health care patient portal 114. At least one of the set of electronic health-related records 128 is presented with the source identifier and the sharing status associated with the at least one of the set of electronic health-related records 128. The control flow exits at step 2014.

FIG. 21 is an operational flow diagram illustrating another example of an overall process for managing access to patient health-related information in a health care patient portal. The operational flow of FIG. 21 beings a step 2102 and flows directly to step 2104. The portal manager 118, at step 2104, receives a set of electronic health-related records 128 associated with at least one user from at least one source. The portal manager 118, at step 2106, assigns a source identifier to each of the set of electronic health-related records 128 based on receiving the records 128. The source identifier identifies the source as one of the user, an entity integrated with the health care patient portal, and an entity that fails to be integrated with the health care patient portal.

The portal manager 118, at step 2108, determines that the user has accessed the health care patient portal 114. The portal manager 118, at step 2110, retrieves the set of electronic health-related records 128 associated with the user. The portal manager 118, at step 2112, identifies the source identifier associated with each of the set of health-related records. The portal manager 118, at step 2114, determines a sharing status associated with each of the set of health-related records 128. The sharing status indicates that the associated electronic health-related record 128 is one of sharable and non-sharable with an entity other than the user. The portal manager 118, at step 2116, presents the set of electronic health-related records 128 to the user in one or more user-customizable widgets within the health care patient portal 114. At least one of the set of electronic health-related records 128 is presented with the source identifier and the sharing status associated with the at least one of the set of electronic health-related records 128. The control flow exits at step 2118.

Information Processing System

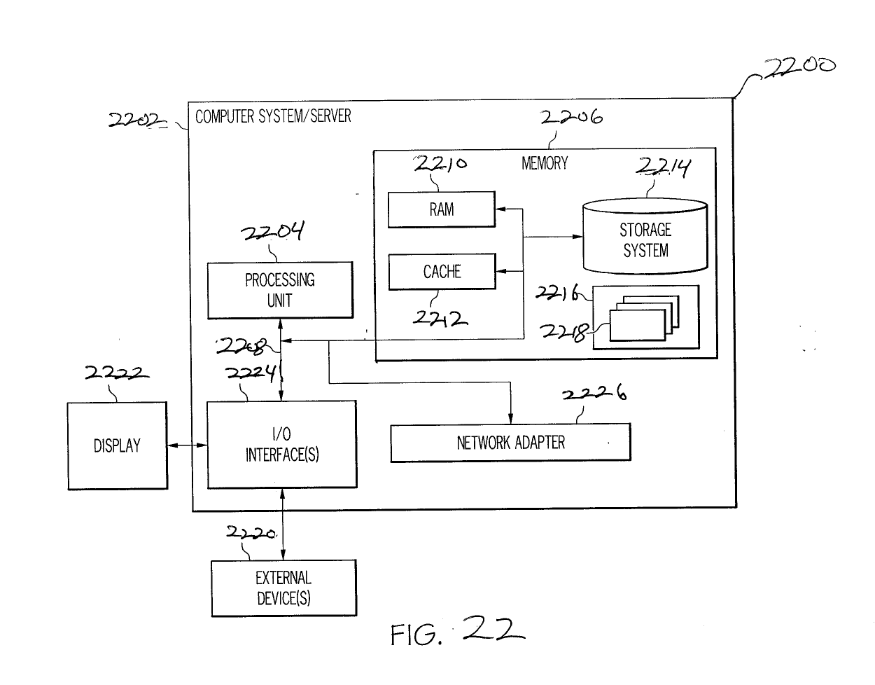

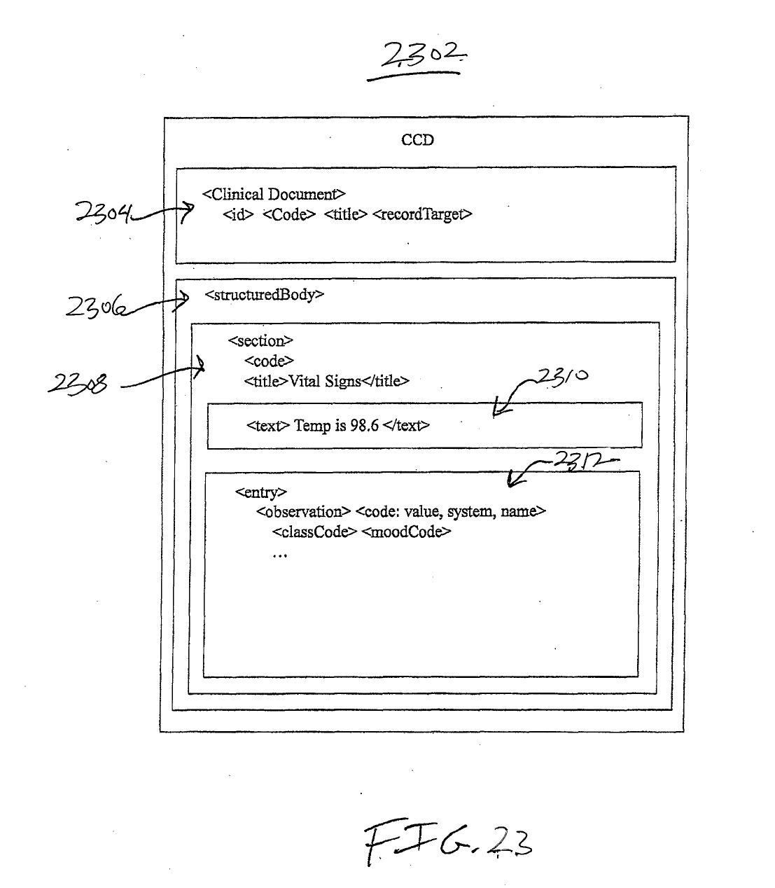

FIG. 22 shows a block diagram illustrating an information processing system 2200 that can be utilized in various embodiments of the present disclosure such as the information processing system 102 shown in FIG. 1. The information processing system 2202 is based upon a suitably configured processing system configured to implement one or more embodiments of the present disclosure. Any suitably configured processing system can be used as the information processing system 2202 in embodiments of the present disclosure. The components of the information processing system 2202 can include, but are not limited to, one or more processors or processing units 2204, a system memory 2206, and a bus 2208 that couples various system components including the system memory 2206 to the processor 2204.

The bus 2208 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 22, the main memory 2206 includes at the patient portal 114, its components including the portal manager 118, the user profiles 120, the facility profiles 122, the subscriber profiles 124, and the health/medical data 126 and records 128 shown in FIG. 1. The portal manager 118 can reside within the processor 2204, or be a separate hardware component. The system memory 2206 can also include computer system readable media in the form of volatile memory, such as random access memory (RAM) 2210 and/or cache memory 2212. The information processing system 2202 can further include other removable/non-removable, volatile/non-volatile computer system storage media. By way of example only, a storage system 2214 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 2208 by one or more data media interfaces. The memory 2206 can include at least one program product having a set of program modules that are configured to carry out the functions of an embodiment of the present disclosure.

Program/utility 2216, having a set of program modules 2218, may be stored in memory 2206 by way of example, and not limitation, as well as an operating system, one or more application programs, other program modules, and program data. Each of the operating system, one or more application programs, other program modules, and program data or some combination thereof, may include an implementation of a networking environment. Program modules 2218 generally carry out the functions and/or methodologies of embodiments of the present disclosure.

The information processing system 2202 can also communicate with one or more external devices 2220 such as a keyboard, a pointing device, a display 2222, etc.; one or more devices that enable a patient to interact with the information processing system 2202; and/or any devices (e.g., network card, modem, etc.) that enable computer system/server 2202 to communicate with one or more other computing devices. Such communication can occur via I/O interfaces 2224. Still yet, the information processing system 2202 can communicate with one or more networks such as a local area network (LAN), a general wide area network (WAN), and/or a public network (e.g., the Internet) via network adapter 2226. As depicted, the network adapter 2226 communicates with the other components of information processing system 2202 via the bus 2208. Other hardware and/or software components can also be used in conjunction with the information processing system 2202. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. Also, the phrase “such as” is not intended to limit the disclosure to any particular item being referred to. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing access to patient health-related information in a health care patient portal, the method comprising:
determining, by an information processing system comprising a health care patient portal, that a user has accessed the health care patient portal;
identifying a set of electronic health-related records associated with the user;
identifying a source identifier associated with each of the set of electronic health-related records, wherein the source identifier is associated with an entity that provided the electronic health-related record to the health care patient portal;
determining a sharing status associated with each of the set of electronic health-related records, wherein the sharing status indicates that the associated electronic health-related record is one of sharable and non-sharable with an entity other than the user; and
presenting the set of electronic health-related records to the user in the health care patient portal, wherein at least one of the set of electronic health-related records is presented with the source identifier and the sharing status associated with the at least one of the set of electronic health-related records.

2. The method of claim 1, wherein the source identifier identifies the entity as being one of the user, an entity integrated with the health care patient portal, and an entity that fails to be integrated with the health care patient portal.

3. The method of claim 1, further comprising:
receiving, from the user, a request to change the sharing status of at least one of the set of electronic health-related records; and
updating the sharing status of the least one of the set of electronic health-related records based on the request received from the user.

4. The method of claim 1, further comprising:
receiving a request from the user to provide access for a health care provider to one or more electronic health-related records associated with the user; and
automatically generating, based on receiving the request, authentication credentials for the health care provider, wherein the authentication credentials comprise a health care patient portal login username, a health care patient portal login password, and an identifier associated with the user.

5. The method of claim 4, further comprising:
transmitting the authentication credentials to the health care provider.

6. The method of claim 1, further comprising:
determining that an entity other than the user has accessed the health care patient portal to view electronic health-related records associated with the user;
identifying, based on the determining, the set of electronic health-related records associated with the user;
determining a sharing status associated with each of the set of electronic health-related records;
based on at least a first electronic health-related record in the set of electronic health-related records being in a shared state, presenting the at least first electronic health-related record to the entity in the health care patient portal; and
based on at a least a second electronic health-related record in the set of electronic health-related records being in a hidden state, preventing the at least second electronic health-related record from being presented to the entity in the health care patient portal.

7. The method of claim 1, further comprising:
receiving, by the health care patient portal, a set of electronic health-related information associated with the user from a source;
identifying, based on the receiving, that the source is one of the user, an entity integrated with the health care patient portal, and an entity that fails to be integrated with the health care patient portal; and
storing the set of electronic health-related information with a source identifier, wherein the source identifier indicates that the set of set of electronic health-related information was received from one of the user, an entity integrated with the health care patient portal, and an entity that fails to be integrated with the health care patient portal.

8. The method of claim 1, wherein presenting the set of electronic health-related records comprises presenting the set of electronic health-related records within in one or more customizable widgets within the health care patient portal.

9. The method of claim 1, further comprising:
receiving a set of electronic health-related information from at least one of the user, a health care provider associated with the user, and an electronic health management system associated with a health care provider of the user, wherein the set of electronic health-related information comprise at least one of structured data and unstructured data.

10. The method of claim 9, wherein receiving the set of electronic health-related information comprises receiving one of a continuity of care document, a continuity of care record, and an unstructured document based on a clinical document architecture.

11. An information processing system for managing access to patient health-related information in a health care patient portal, the information processing system comprising:
memory;
a processor communicatively coupled to the memory;
a health care patient portal; and
a portal manager, wherein the portal manager is configured to perform a method comprising:
receiving, from a at least one source, a set of electronic health-related records associated with at least one user;
assigning, based on the receiving, a source identifier to each of the set of electronic health-related records identifying the source as one of the user, an entity integrated with the health care patient portal, and an entity that fails to be integrated with the health care patient portal;
determining that the user has accessed the health care patient portal;
retrieving the set of electronic health-related records associated with the user;
identifying the source identifier associated with each of the set of health-related records;
determining a sharing status associated with each of the set of health-related records, wherein the sharing status indicates that the associated electronic health-related record is one of sharable and non-sharable with an entity other than the user; and
presenting the set of electronic health-related records to the user in one or more user-customizable widgets within the health care patient portal, wherein at least one of the set of electronic health-related records is presented with the source identifier and the sharing status associated with the at least one of the set of electronic health-related records.

12. A computer program storage product for managing access to patient health-related information in a health care patient portal, the computer program storage product comprising instructions configured to perform a method comprising:
determining, by an information processing system comprising a health care patient portal, that a user has accessed the health care patient portal;
identifying a set of electronic health-related records associated with the user;
identifying a source identifier associated with each of the set of electronic health-related records, wherein the source identifier is associated with an entity that provided the electronic health-related record to the health care patient portal;
determining a sharing status associated with each of the set of electronic health-related records, wherein the sharing status indicates that the associated electronic health-related record is one of sharable and non-sharable with an entity other than the user; and
presenting the set of electronic health-related records to the user in the health care patient portal, wherein at least one of the set of electronic health-related records is presented with the source identifier and the sharing status associated with the at least one of the set of electronic health-related records.

13. The computer program storage product of claim 12, wherein the source identifier identifies the entity as being one of the user, an entity integrated with the health care patient portal, and an entity that fails to be integrated with the health care patient portal.

14. The computer program storage product of claim 12, wherein the method further comprises:
receiving, from the user, a request to change the sharing status of at least one of the set of electronic health-related records; and
updating the sharing status of the least one of the set of electronic health-related records based on the request received from the user.

15. The computer program storage product of claim 12, wherein the method further comprises:
receiving a request from the user to provide access for a health care provider to one or more electronic health-related records associated with the user; and
automatically generating, based on receiving the request, authentication credentials for the health care provider, wherein the authentication credentials comprise a health care patient portal login username, a health care patient portal login password, and an identifier associated with the user.

16. The computer program storage product of claim 12, wherein the method further comprises:
determining that an entity other than the user has accessed the health care patient portal to view electronic health-related records associated with the user;
identifying, based on the determining, the set of electronic health-related records associated with the user;
determining a sharing status associated with each of the set of electronic health-related records;
based on at least a first electronic health-related record in the set of electronic health-related records being in a shared state, presenting the at least first electronic health-related record to the entity in the health care patient portal; and
based on at a least a second electronic health-related record in the set of electronic health-related records being in a hidden state, preventing the at least second electronic health-related record from being presented to the entity in the health care patient portal.

17. The computer program storage product of claim 12, wherein the method further comprises:
receiving, by the health care patient portal, a set of electronic health-related information associated with the user from a source;
identifying, based on the receiving, that the source is one of the user, an entity integrated with the health care patient portal, and an entity that fails to be integrated with the health care patient portal; and
storing the set of electronic health-related information with a source identifier, wherein the source identifier indicates that the set of set of electronic health-related information was received from one of the user, an entity integrated with the health care patient portal, and an entity that fails to be integrated with the health care patient portal.

18. The computer program storage product of claim 12, wherein presenting the set of electronic health-related records comprises presenting the set of electronic health-related records within in one or more customizable widgets within the health care patient portal.

19. The computer program storage product of claim 12, wherein the method further comprises:
receiving a set of electronic health-related information from at least one of the user, a health care provider associated with the user, and an electronic health management system associated with a health care provider of the user, wherein the set of electronic health-related information comprise at least one of structured data and unstructured data.

20. The computer program storage product of claim 19, wherein receiving the set of electronic health-related information comprises receiving one of a continuity of care document, a continuity of care record, and an unstructured document based on a clinical document architecture.
